(19) United States
(12) Patent Application Publication
(10) Pub. No.: US 2025/0016746 A1
(43) Pub. Date: Jan. 9, 2025

(54) USER EQUIPMENT, RADIO NETWORK NODE AND METHODS PERFORMED IN A WIRELESS COMMUNICATION NETWORK

(71) Applicant: Telefonaktiebolaget LM Ericsson (publ), Stockholm (SE)

(72) Inventors: Stephen GRANT, Pleasanton, CA (US); Jung-Fu CHENG, Fremont, CA (US)

(21) Appl. No.: 18/706,082

(22) PCT Filed: Nov. 4, 2022
(86) PCT No.: PCT/SE2022/051014

§ 371 Date: Apr. 30, 2024

Related U.S. Application Data
(60) Provisional application No. 63/263,587, filed on Nov. 5, 2021.

(51) Int. Cl. H04W 72/0446; H04L 5/00

(52) U.S. Cl. CPC H04W 72/0446; H04L 5/0094

(57) ABSTRACT

Embodiments herein relate to, for example, a method performed by a UE for handling communication in a wireless communication network. The UE selects for a Pcell, and/or a Scell, a search space slot within a slot group wherein the slot group is arranged in an X-slot group pattern, wherein the slot group is of a size of X-slots, and the X-slot group pattern is fixed relative to a reference time location and common for UEs operating PDCCH monitoring X slots. The UE further monitors the selected search space slot or slots for a control channel of the Pcell, and/or the Scell.

### TECHNICAL FIELD

Embodiments herein relate to a user equipment (UE), a radio network node and methods performed therein regarding wireless communication. Furthermore, a computer program product and a computer-readable storage medium are also provided herein. Especially, embodiments herein relate to handling or enabling monitoring of a control channel in a wireless communication network.

### BACKGROUND

In a typical wireless communication network, UEs, also known as wireless communication devices, mobile stations, stations (STA) and/or wireless devices, communicate via a Radio access Network (RAN) to one or more core networks (CN). The RAN covers a geographical area which is divided into service areas or cell areas, with each service area or cell area being served by a radio network node such as an access node, e.g., a Wi-Fi access point or a radio base station (RBS), which in some radio access technologies (RAT) may also be called, for example, a NodeB, an evolved NodeB (eNodeB) and a gNodeB (gNB). The service area or cell area is a geographical area where radio coverage is provided by the radio network node. The radio network node operates on radio frequencies to communicate over an air interface with the wireless devices within range of the access node. The radio network node communicates over a downlink (DL) to the wireless device and the wireless device communicates over an uplink (UL) to the access node.

A Universal Mobile Telecommunications System (UMTS) is a third generation telecommunication network, which evolved from the second generation (2G) Global System for Mobile Communications (GSM). The UMTS terrestrial radio access network (UTRAN) is essentially a RAN using wideband code division multiple access (WCDMA) and/or High-Speed Packet Access (HSPA) for communication with user equipments. In a forum known as the Third Generation Partnership Project (3GPP), telecommunications suppliers propose and agree upon standards for present and future generation networks and UTRAN specifically, and investigate enhanced data rate and radio capacity. In some RANs, e.g., as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. The RNCs are typically connected to one or more core networks.

Specifications for the Evolved Packet System (EPS) have been completed within the 3^{rd} Generation Partnership Project (3GPP) and this work continues in the coming 3GPP releases (Rel). The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a 3GPP radio access technology wherein the radio network nodes are directly connected to the EPC core network. As such, the Radio Access Network (RAN) of an EPS has an essentially “flat” architecture comprising radio network nodes connected directly to one or more core networks.

With the emerging 5G technologies also known as new radio (NR), the use of, e.g., very many transmit- and receive-antenna elements makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals from a selected direction or directions, while suppressing unwanted signals from other directions.

Mobile broadband will continue to drive the demands for big overall traffic capacity and huge achievable end-user data rates in the wireless access network. Several scenarios in the future will require data rates of up to 10 Gbps in local areas. These demands for very high system capacity and very high end-user date rates can be met by networks with distances between access nodes ranging from a few meters in indoor deployments up to roughly 50 m in outdoor deployments, i.e., with an infra-structure density considerably higher than the densest networks of today.

In 3GPP release (Rel)-15, a 5G system referred as New Radio (NR) was specified. NR standard in 3GPP is designed to provide services for multiple use cases such as enhanced mobile broadband (eMBB), ultra-reliable and low latency communication (URLLC), and machine type communication (MTC). Each of these services has different technical requirements. For example, the general requirement for eMBB is high data rate with moderate latency and moderate coverage, while URLLC service requires a low latency and high reliability transmission but perhaps for moderate data rates.

Besides traditional licensed exclusive bands, NR systems are currently being extended expected to operate on unlicensed bands. The NR system specifications currently address two frequency ranges, FR1 and FR2, which are summarized in TABLE 1. To support ever growing mobile traffic, further extension of the NR system to support spectrum higher than 5.26 GHz is expected in the near future.

TABLE 1
Frequency ranges supported by the current NR system.

| Frequency range (FR) designation | Corresponding frequency range |
|---|---|
| FR1 | 410 MHz-7125 MHz |
| FR2 | 24250 MHz-52600 MHz |

### Overview of Rel-15 NR System.

### Numerology and Bandwidth Consideration for NR

The downlink transmission waveform in NR is conventional orthogonal frequency division multiplexing (OFDM) using a cyclic prefix. The uplink transmission waveform is conventional OFDM using a cyclic prefix (CP) with a transform precoding function performing discrete fourier transform (DFT) spreading that can be disabled or enabled. The basic transmitter block diagram for NR is illustrated in FIG. 1, which shows NR transmitter block diagram for CP-OFDM with optional DFT-spreading.

Multiple numerologies are supported in NR. A numerology is defined by sub-carrier spacing and CP overhead. Multiple subcarrier spacings (SCS) can be derived by scaling a basic subcarrier spacing by an integer 2^{μ}. The numerology used can be selected independently of the frequency band although it is assumed not to use a very small subcarrier spacing at very high carrier frequencies. Flexible network and UE channel bandwidths are supported. The supported transmission numerologies in NR are summarized in Table 2.

TABLE 2
Transmission numerologies supported in NR.

| | | | Supported | Supported |
|---|---|---|---|---|
| μ | Δf = 2^{μ} · 15[kHz] | Cyclic prefix | for data | for synch |
| 0 | 15 | Normal | Yes | Yes |
| 1 | 30 | Normal | Yes | Yes |
| 2 | 60 | Normal, Extended | Yes | No |
| 3 | 120 | Normal | Yes | Yes |
| 4 | 240 | Normal | No | Yes |

From RAN1 specification perspective, maximum channel bandwidth per NR carrier is 400 MHz in Rel-15. At least for single numerology case, candidates of the maximum number of subcarriers per NR carrier is 3300 in Rel-15 from RAN1 specification perspective.

Downlink and uplink transmissions are organized into frames with 10 ms duration, consisting of ten 1 ms subframes. Each frame is divided into two equally-sized half-frames of five subframes each. The slot duration is 14 symbols with Normal CP and 12 symbols with Extended CP, and scales in time as a function of the used sub-carrier spacing so that there is always an integer number of slots in a subframe. More specifically, the number of slots per subframe is 2^{μ}.

The basic NR downlink physical resource within a slot can thus be seen as a time-frequency grid as illustrated in FIG. 2 for 15 kHz sub-carrier spacing numerology, where each resource element corresponds to one OFDM subcarrier during one OFDM symbol interval. A resource block is defined as 12 consecutive subcarriers in the frequency domain. The uplink subframe has the same subcarrier spacing as the downlink and the same number of single carrier frequency-division multiple access (SC-FDMA) symbols in the time domain as OFDM symbols in the downlink.

### Carrier Aggregation (CA) and Dual Connectivity (DC) in NR.

In the case of carrier aggregation, multiple NR carriers can be transmitted in parallel to/from the same UE, thereby allowing for an overall wider bandwidth and correspondingly higher per-link data rates. In the context of carrier aggregation, each carrier is referred to as a serving cell in the specifications. In NR, a UE first connects to the network with a serving cell, which becomes the primary cell (PCell) for the UE, which continues to handle the mobility and radio resource control (RRC) connection of the UE. The additional aggregated cells are referred to as the secondary cells (SCells).

In addition to carrier aggregation with one PCell and one or more SCells as one cell group, NR also supports a second cell group with at one primary secondary cell (PSCell) and possible additional SCells in the second cell group.

### Physical Layer Downlink Control Channel (PDCCH) Monitoring in NR.

In 3GPP NR standard, downlink control information (DCI) is received over the PDCCH. The PDCCH may carry DCI in messages with different formats. DCI format 0_0 and 0_1 are DCI messages used to convey uplink grants to the UE for transmission of the physical layer data channel in the uplink, denoted as physical uplink shared channel (PUSCH) and DCI format 1_0 and 1_1 are used to convey downlink grants for transmission of the physical layer data channel on the downlink, denotes as physical downlink shared channel (PDSCH). Other DCI formats, such as 2_0, 2_1, 2_2 and 2_3, are used for other purposes such as transmission of slot format information, reserved resource, transmit power control information etc.

A PDCCH candidate is searched within a common or UE-specific search space which is mapped to a set of time and frequency resources referred to as a control resource set (CORESET) instance. The search spaces within which PDCCH candidates must be monitored are configured to the UE via RRC signaling. A monitoring periodicity is also configured for different search space sets. A CORESET is defined by the frequency domain location and size as well as the time domain size. A CORESET in NR can be 1, 2 or 3 OFDM symbols in duration. The smallest unit used for defining CORESETs is a Resource Element Group (REG), which is defined as spanning 12 subcarriers×1 OFDM symbol in frequency and time. Resource-element groups within a control-resource set are numbered in increasing order in a time-first manner, starting with 0 for the first OFDM symbol and the lowest-numbered resource block in the control resource set. As a result, though different PDCCHs can occupy different amount of frequency domain resources, all PDCCHs in a CORESET have the same duration as the duration of the CORESET.

Each REG contains demodulation reference signals (DMRS) to aid in the estimation of the radio channel over which that REG was transmitted. When transmitting the PDCCH, a precoder could be used to apply weights at the transmit antennas based on some knowledge of the radio channel prior to transmission. It is possible to improve channel estimation performance at the UE by estimating the channel over multiple REGs that are proximate in time and frequency if the precoder used at the transmitter for the REGs is not different. To assist the UE with channel estimation the multiple REGs can be grouped together to form a REG bundle and the REG bundle size for a CORESET is indicated to the UE. The UE may assume that any precoder used for the transmission of the PDCCH is the same for all the REGs in the REG bundle. A REG bundle may consist of 2, 3 or 6 REGs.

A control channel element (CCE) consists of 6 REGs. The REGs within a CCE may either be contiguous or distributed in frequency. When the REGs are distributed in frequency, the CORESET is said to be using an interleaved mapping of REGs to a CCE and if the REGs are not distributed in frequency, a non-interleaved mapping is said to be used.

PDCCHs targeting different coverage ranges are designed based assigning different amount of frequency domain resources to the PDCCHs. A PDCCH candidate may span 1, 2, 4, 8 or 16 CCEs and the number of aggregated CCEs used is referred to as the aggregation level for the PDCCH candidate.

### Search Space Sets.

A set of PDCCH candidates for a UE to monitor is defined in terms of PDCCH search space sets. A search space set can be a common search space (CSS) set or a UE-specific search space (USS) set. A UE monitors PDCCH candidates in one or more of the following search spaces sets:
a Type0-PDCCH CSS set configured by pdcch-ConfigSIB1 in master information block (MIB) or by searchSpaceSIB1 in PDCCH-ConfigCommon or by searchSpaceZero in PDCCH-ConfigCommon for a DCI format with cyclic redundancy check (CRC) scrambled by a system information-Radio Network Temporary Identifier (SI-RNTI) on the primary cell of the master cell group (MCG);
a Type0A-PDCCH CSS set configured by searchSpaceOtherSystemInformation in PDCCH-ConfigCommon for a DCI format with CRC scrambled by a SI-RNTI on the primary cell of the MCG;
a Type1-PDCCH CSS set configured by ra-SearchSpace in PDCCH-ConfigCommon for a DCI format with CRC scrambled by a random access (RA)-RNTI, a MsgB-RNTI, or a temporary cell (TC)-RNTI on the primary cell;
a Type2-PDCCH CSS set configured by pagingSearchSpace in PDCCH-ConfigCommon for a DCI format with CRC scrambled by a paging (P)-RNTI on the primary cell of the MCG;
a Type3-PDCCH CSS set configured by SearchSpace in PDCCH-Config with searchSpaceType=common for DCI formats with CRC scrambled by interruption (INT)-RNTI, slot format indication (SFI)-RNTI, transmit power control (TPC)-PUSCH-RNTI, TPC-PUCCH-RNTI, TPC-sounding reference signal (SRS)-RNTI, or CI-RNTI and, only for the primary cell, cell (C)-RNTI, Modulation and coding scheme (MCS)-C-RNTI, configured scheduling (CS)-RNTI(s), or PS-RNTI and
a USS set configured by SearchSpace in PDCCH-Config with searchSpaceType=ue-Specific for DCI formats with CRC scrambled by C-RNTI, MCS-C-RNTI, Semi-Persistent (SP)-channel state information (CSI)-RNTI, CS-RNTI(s), sidelink (SL)-RNTI, SL-CS-RNTI, or SL Semi-Persistent Scheduling vehicle (V)-RNTI.

### Type0-PDCCH and System Information Block Type1 (SIB1).

SIB1 is scheduled on PDSCH by PDCCH scrambled with SI-RNTI in the Type0-PDCCH common search space set. If during cell search a UE determines from MIB that a CORESET for Type0-PDCCH CSS set is present, as described in Subclause 4.1 of 38.213, the UE determines a number of consecutive resource blocks and a number of consecutive symbols for the CORESET of the Type0-PDCCH CSS set from controlResourceSetZero (simply an index to a row in a first table) in pdcch-ConfigSIB1, as described in Tables 13-1 through 13-10 in 38.213. These tables provide the configuration, duration, bandwidth, and physical resource block (PRB) location of CORESET0. The UE determines the configuration of the PDCCH monitoring occasions from searchSpaceZero, simply and index to a row in a second table, in pdcch-ConfigSIB1, included in MIB, as described in Tables 13-11 through 13-15 in 38.213 v.16.0.0.

For synchronization signal (SS)/physical broadcast channel (PBCH) block and CORESET multiplexing pattern 1, the UE monitors two consecutive slots starting from the one indicated by the procedure in 38.213 § 13 v.16.0.0 denoted by slot n₀ and slot n₀+1.

The UE determines which table, Tables 13-1 through 13-10, to use based on a combination of the sub-carrier spacing for the detected SS/PBCH block, as defined in 38.101-1 per band, the sub-carrier spacing of PDCCH, as indicated by subCarrierSpacingCommon in MIB, the frequency range FR1/FR2, and the minimum channel bandwidth, as defined by 38.101-1 per band v.16.0.0.

There are a number of exceptions where 38.101-1/2 defines two different sub-carrier spacings for the SS/PBCH block for a band. For those cases the UE needs to try both sub-carrier spacings when detecting the SS/PBCH block.

### Search Space Configuration.

In Rel-15/16, the RRC parameter monitoringSlotPeriodicityAndOffset is used to configure the periodicity and offset of the search space.

The parameter duration indicates the number of consecutive slots for PDCCH monitoring occasions within the search space set configuration periodicity. If the field is absent, the UE applies the value 1 slot, except for DCI format 2_0. The UE ignores this field for DCI format 2_0.

The first symbol(s) for PDCCH monitoring in the slots configured for PDCCH monitoring is determined by the bitmap in monitoringSymbolsWithinSlot. The most significant (left) bit represents the first OFDM in a slot, and the second most significant (left) bit represents the second OFDM symbol in a slot and so on. The bit(s) set to one identify the first OFDM symbol(s) of the control resource set within a slot.

| | |
|---|---|
| SearchSpace::= | SEQUENCE { |
| searchSpaceId | SearchSpaceId, |
| controlResourceSetId | ControlResourceSetId |
| monitoringSlotPeriodicityAndOffset | CHOICE { |
| s11 | NULL, |
| s12 | INTEGER (0..1), |
| s14 | INTEGER (0..3), |
| s15 | INTEGER (0..4), |
| s18 | INTEGER (0..7), |
| s110 | INTEGER (0..9), |
| s116 | INTEGER (0..15), |
| s120 | INTEGER (0..19), |
| s140 | INTEGER (0..39), |
| s180 | INTEGER (0..79), |
| s1160 | INTEGER (0..159), |
| s1320 | INTEGER (0..319), |
| s1640 | INTEGER (0..639), |
| s11280 | INTEGER (0..1279), |
| s12560 | INTEGER (0..2559) |

}

| | |
|---|---|
| duration | INTEGER (2..2559), |
| monitoringSymbolsWithinSlot | BIT STRING (SIZE (14)) |

...

PDCCH Processing Capability Requirements and Limitations for High Frequency Systems.

Blind decoding of potential PDCCH transmissions is attempted by the UE in each of the configured PDCCH candidates within a slot. In any particular slot, the UE may be configured to monitor multiple PDCCH candidates in multiple search spaces which may be mapped to one or more CORESETs. PDCCH candidates may need to be monitored multiple times in a slot, once every slot or once in multiple of slots. The maximum number of PDCCH candidates that can be monitored by a UE for a carrier within a slot are summarized in Table 3. The complexity incurred at the UE to do this depends on the number of CCEs which need to be processed to test all the candidates in the CORESET. Channel estimation is a key contributor to the complexity incurred by the UE. The maximum number of CCEs of channel estimation supported by the UE for a carrier within a slot are summarized in Table 3.

| SCS | 15 kHz | 30 kHz | 60 kHz | 120 kHz |
|---|---|---|---|---|
| Max # of candidates | 44 | 36 | 22 | 20 |
| Max # of CCE estimation | 56 | 56 | 48 | 32 |

Table 3 shows Maximum number of PDCCH candidates and maximum number of CCE for channel estimation within a slot for a carrier.

The Rel-15 PDCCH processing capabilities per slot can be fitted to simple formulae to obtain initial benchmarks for further discussion. Using the minimum mean absolute deviation fitting, the fitted formulae is given by

$${N}_{BD , μ}^{slot} ≅ 44 \times {2}^{- 0.38 μ}$$

$${N}_{CCE , μ}^{slot} ≅ 62.6 \times {2}^{- 0.32 μ}$$

The fitted and extrapolated PDCCH processing capabilities per slot are shown in Table 4, where the values for 240 kHz SCS and above are extrapolated values for sub-carrier spacings larger than 120 kHz. Since N_{CCE,μ}^{slot} for μ=0 and μ=1 are identical, the fitting takes a nominal μ=0.5 to pair with N_{CCE,μ}^{slot}=56 as input. It can be observed that UE processing capabilities may become extremely limited when using large sub-carrier spacing and very short frame structures for high-frequency bands. There are then doubts on whether the UE operating with ≥1920 kHz SCS can support even one aggregation level (AL)-16 PDCCH or the default number of candidates for monitoring the seven PDCCH candidates in Type0A-PDCCH CSS as specified in NR specs.

TABLE 4
Extrapolated N_BD\hat{ }slot and N_CCE\hat{ }slot values per slot.

| μ | 0 | 1 | 2 | 3 | 4 | 5 | 6 | 7 | 8 |
|---|---|---|---|---|---|---|---|---|---|
| SCS [kHz] | 15 | 30 | 60 | 120 | 240 | 480 | 960 | 1920 | 3840 |
| N_{BD, μ}^{slot} | 44 | 36 | 22 | 20 | | | | | |
| Estimate | 44 | 34 | 26 | 20 | 15 | 12 | 9 | 7 | 5 |

| | | | | | | | | |
|---|---|---|---|---|---|---|---|---|
| SCS [kHz] | 15*2^{0.5} | 60 | 120 | 240 | 480 | 960 | 1920 | 3840 |
| N_{CCE, μ}^{slot} | 56 | 48 | 32 | | | | | |
| Estimate | 56 | 40 | 32 | 26 | 20 | 16 | 13 | 10 |

One possible direction is to reduce the periodicity of PDCCH monitoring at a UE to allow more time for the UE to process the PDCCH candidates. For instance, FIG. 3 illustrates a case where the UE is configured to monitor PDCCH candidates every slot bundle with bundling size X=4 slots.

Thus, FIG. 3 shows an Example of multi-slot PDCCH monitoring with periodicity X=4.

### Beam-Forming Centric Transmission for NR Operation in Mm-Wave Frequency.

As the operating frequency of wireless networks increases and moves to milli-meter wave territory, data transmission between nodes suffers from high propagation loss, which is proportional to the square of the carrier frequency. Moreover, milli-meter wave signal also suffers from high oxygen absorption, high penetration loss and a variety of blockage problems. On the other hand, with the wavelength as small as less than a centi-meter, it becomes possible to pack a large amount, tens, hundreds or even thousands, of antenna elements into a single antenna array with a compact formfactor, which can be widely adopted in a network equipment and a user device. Such antenna arrays and/or panels can generate narrow beams with high beam forming gain to compensate for the high path loss in mm-wave communications, as well as providing highly directional transmission and reception pattern. As a consequence, directional transmission and reception are the distinguishing characteristics for wireless networks in mm-wave bands. In the case of analog beamforming where the amplitude and/or phase of each antenna element is adjusted as RF, a transmitter/receiver can typically only transmit/receive in one direction at a time, or if the UE is equipped with two or more panels, a few directions at any given time. This is in contrast to digital or hybrid analog-digital beamforming, where the phase weights are applied at baseband allowing different beam directions in different frequency sub-bands.

### PDCCH TCI States.

To support beam-based operation in NR, a UE can be configured with a number of transmission configuration indicator (TCI) states. A TCI state, see below extract from 38.331 v.16.0.0, provides the UE with the ID of one or two reference signals, where each reference signal can be an SS/PBCH block or a channel state information reference signal (CSI-RS). A quasi-co-location (QCL) type is associated with each of the reference signals of the TCI state, and the type can take one of 4 possible values: TypeA, TypeB, TypeC, or TypeD. A particular TCI state is indicated to the UE to aid in the reception of other signals/channels in the DL, e.g., PDSCH, PDCCH, other CSI-RS, etc. The indication of the TCI state to aid in reception of a DL signal is performed through either dynamic or semi-static signaling, i.e., via DCI, medium access control (MAC)-control element (CE), or by RRC depending on the DL signal to be received. For example, for reception of PDCCH, a TCI state is indicated by MAC-CE signaling.

QCL type is related to the spatial domain receiver settings in the UE, i.e., the setting of the spatial domain receive filter, receive beamforming weights. Hence, if TypeD is configured for one of the reference signals of the indicated TCI state for reception of a DL signal, e.g., PDCCH, it tells the UE that it can receive the PDCCH with the same spatial domain receiver settings as it used to receive the reference signal configured with TypeD within the TCI state. The implicit assumption is that the UE has previously performed measurements on this reference signal and “remembers” which spatial domain receiver settings it used for reception of that reference signal. In other words, the TCI state provides a means to indicate to the UE which receive beam to use for reception of the DL signal, e.g., PDCCH.

| TCI State ::= | SEQUENCE { |
|---|---|
| tci-StateId | TCI-StateId; |
| qcl-Type1 | QCL-Info; |
| qcl-Type2 | QCL-Info |
| OPTIONAL, -- Need R | |
| ... | |
| } | |
| QCL-Info ::= | SEQUENCE { |
| cell | ServCellIndex |
| OPTIONAL, -- Need R | |
| bwp-Id | BWP-Id |
| OPTIONAL, -- Cond CSI-RS-Indicated | |
| referenceSignal | CHOICE { |
| csi-rs | NZP-CSI-RS-ResourceId; |
| ssb | SSB-Index |
| }, | |
| qcl-Type | ENUMERATED {typeA, typeB, typeC, |

```
typeD},
    ...
  }
```

QCL-Info field descriptions

bwp-Id
The DL BWP which the RS is located in.
cell
The UE's serving cell in which the referenceSignal is configured. If the
field is absent, it applies to the serving cell in which the TCI-State is
configured. The RS can be located on a serving cell other than the serving
cell in which the TCI-State is configured only if the qcl-Type is configured
as typeC or typeD. See TS 38.214 [19] clause 5.1.5.
referenceSignal
Reference signal with which quasi-collocation information is provided as
specified in TS 38.214 [19] subclause 5.1.5.
qcl-Type
QCL type as specified in TS 38.214 [19] subclause 5.1.5.

| Conditional Presence | Explanation |
|---|---|
| CSI-RS-Indicated | This field is mandatory present if csi-rs |
| | is included, absent otherwise |

### MAC-CE Activation of TCI State for PDCCH.

The indication (activation) of the TCI state to aid in reception of PDCCH is performed by MAC-CE signaling according to the following extract from 3GPP TS 38.321. The highlighted text covers the case where MAC-CE activates the TCI state for CORESET0. When MAC-CE indicates (activates) the TCI state for CORESET0, then this TCI state is used for the reception of PDCCH detected in any search space that has configured association to CORESET0, e.g., a search space with index 0, SS0.

### TCI State Indication for UE-Specific PDCCH MAC CE.

The TCI State Indication for UE-specific PDCCH MAC CE is identified by a MAC subheader with logic channel identity (LCID) as specified in Table 6.2.1-1. It has a fixed size of 16 bits with following fields:
Serving Cell ID: This field indicates the identity of the Serving Cell for which the MAC CE applies. The length of the field is 5 bits. If the indicated Serving Cell is configured as part of a simultaneousTCI-UpdateList1 or simultaneousTCI-UpdateList2 as specified in TS 38.331 [5], this MAC CE applies to all theServing Cells in the set simultaneousTCI-UpdateList1 or simultaneousTCI-UpdateList2, respectively;
CORESET ID: This field indicates a Control Resource Set identified with ControlResourceSetId as specified in TS 38.331 [5], for which the TCI State is being indicated. In case the value of the field is 0, the field refers to the Control Resource Set configured by controlResourceSetZero as specified in TS 38.331 [5]. The length of the field is 4 bits;
TCI State ID: This field indicates the TCI state identified by TCI-StateId as specified in TS 38.331 [5] applicable to the Control Resource Set identified by CORESET ID field. If the field of CORESET ID is set to 0, this field indicates a TCI-StateId for a TCI state of the first 64 TCI-states configured by tci-StatesToAddModList and tci-StatesToReleaseList in the PDSCH-Config in the active BWP. If the field of CORESET ID is set to the other value than 0, this field indicates a TCI-StateId configured by tci-StatesPDCCH-ToAddList and tci-StatesPDCCH-ToReleaseList in the controlResourceSet identified by the indicated CORESET ID. The length of the field is 7 bits.

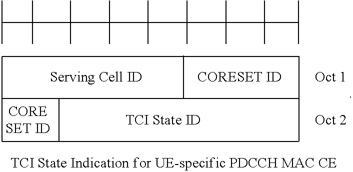

Through indication (activation) of a TCI state, the UE is able to know which direction to tune its receive beam towards the serving gNB for reception of a particular signal or channel, e.g., PDCCH. Based on prior UE measurements and reporting to the gNB, the gNB is able to know how to tune its Tx beam towards the UE. An illustrative example is shown in FIG. 4. gNB with analog beamforming capability can only transmit in the DL in one direction (per antenna panel) at a time. To solve this, the gNB can periodically sweep through all beams in the cell and the UE measures and reports the receive signal strength back to the gNB corresponding to one or more beams with the largest signal strength.

FIG. 4 shows a UE Rx beam adjustment with mobility. FIG. 4 also shows that as the UE moves within a cell, it will need to adjust (change) its receive beam. To aid the UE in such an Rx beam change and maintain the link to the gNB, the gNB can indicate (activate) a new TCI state from a list of TCI states configured to the UE. The TCI state update will typically come as a response to that the UE has reported a stronger received power for a different reference signal, e.g., SSB6 in FIG. 4.

For the case of a Type0/0A/2 PDCCH detected in search space 0 (SS0) associated with CORESET0, the TCI state update procedure is described in 3GPP TS 38.213 v.16.0.0 as follows:

If a UE is provided a zero value for searchSpaceID in PDCCH-ConfigCommon for a Type0/0A/2-PDCCH CSS set, the UE determines monitoring occasions for PDCCH candidates of the Type0/0A/2-PDCCH CSS set as described in clause 13, and the UE is provided a C-RNTI, the UE monitors PDCCH candidates only at monitoring occasions associated with a SS/PBCH block, where the SS/PBCH block is determined by the most recent of
a MAC CE activation command indicating a TCI state of the active bandwidth part (BWP) that includes a CORESET with index 0, as described in [6, TS 38.214], where the TCI-state includes a CSI-RS which is quasi-co-located with the SS/PBCH block, or
a random access procedure that is not initiated by a PDCCH order that triggers a contention-free random access procedure

This procedure also states where the UE shall monitor for the CSS PDCCH. The time domain location, i.e., slot, of the monitoring occasions is a function of the SS/PBCH block determined according to the above procedure.

### SUMMARY

As part of developing embodiments herein one or more problems have been identified.

For the large subcarrier spacings (480, 960 kHz) introduced in Rel-17, it becomes clear that reducing the periodicity of PDCCH monitoring at the UE side can allow more time for the UE to process the PDCCH candidates since the slot duration for the large SCSs becomes quite short. However, it is important to simultaneously consider both UE capability and gNB/network scheduling flexibility. What is needed from a gNB point of view is to be able to stagger USSs for different UEs in different slots based on the preferred spatial beams.

Three alternatives have been proposed to define a multi-slot monitoring capability suitable for the new large SCSs:
Alt 1: Use a fixed pattern of slot groups as the baseline to define the new capability.
   Each slot group consists of X slots
   Slot groups are consecutive and non-overlapping
   The capability indicates the blind detection (BD)/CCE budget within Y consecutive slots in each slot group
      The location of the Y slots within the X slots is maintained across different slot groups
   Further discuss down-selection of Y within 1<=Y<=X/2, both in units of slot, when X>1
   For further study (FFS): Further definition of capabilities
   FFS: The following issues for the search space configuration discussion
      Whether a slot group is aligned with a slot boundary
      Restrictions on location of the Y slots within a slot group, e.g. whether to restrict the location of a SS to be within the first Y slots within a slot group
   FFS: What the UE capability defines for monitoring within the Y slots
Alt 2: Use an (X, Y) span as the baseline to define the new capability
   X is the minimum time separation between the start of two consecutive spans
   The capability indicates the BD/CCE budget within a span of at most Y consecutive [symbols or slots]
   Y<=X
   FFS: Exact values of X and Y and units in which they are defined (e.g., symbols, slots), including cases where a span is longer than one slot or crosses a slot boundary.
   FFS: What is a span pattern, how it is defined and whether it is supported. If it is supported, whether number of slots within which the span pattern is repeated is needed, and if needed, the value of the number of slots.
   FFS: Further definition of capabilities
Alt 3: Use a sliding window of X slots as the baseline to define the new capability.
   The capability indicates the BD/CCE budget within the sliding window
   The sliding unit of the sliding window is [1] slot.
   FFS: Further definition of capabilities

In terms of UE energy savings, smaller Y values (e.g., Y≤1 slot) are preferred. However, as described in the above, the current initial access procedure is built on UE monitoring two consecutive slots for type0 PDCCH. Furthermore, it has been recognized that none of the three alternatives with small Y values and without further changes can support mobility-induced TCI state changes where the time domain monitoring location associated with an SS/PBCH block needs to change.

One may to solve the problems identified in the above:
In a first approach, the fixed pattern of X-slot groups is common to all UEs but the locations of the Y slots within a X-slot group are different for different UEs based on the preferred SS/PBCH block index determined by each UE.
In a second approach, the Y slots are always located at the beginning of a X-slot group but the locations of the X-slot groups are different for different UEs based on the preferred SS/PBCH block index determined by each UE.

For either approach, a search space can be configured with a granularity of X-slot groups (which includes the periodicity in terms of X-slot groups, offset in terms of X-slot groups within the period, and duration in terms of X-slot groups within the period). However, the key aspect is that the slot location of the search spaces within an X-slot group is not configurable. Rather, for a given UE, they are confined within the same Y-slot duration, and the Y slot duration has location corresponding to the first slot of the Type0 CSS within an X-slot group determined by that UE.

An object of embodiments herein is to provide a mechanism that improves the performance in the wireless communication network.

Embodiments herein further provide details and procedures for carrier aggregation or dual connectivity cases and allow compatible search space monitoring occasions between PCell/PSCell and SCells. This enables UE energy saving by supporting small Y values and mobility-induced spatial QCL (TCI state) changes, and simultaneously allows network flexibility to stagger UE specific search spaces in different slots.

According to an aspect the object is achieved by providing a method performed by a UE for handling communication in a wireless communication network. The UE selects for a Pcell and/or a Scell, a search space slot within a slot group wherein the slot group is arranged in an X-slot group pattern, wherein the slot group is of a size of X-slots, and the X-slot group pattern is fixed relative to a reference time location and common for UEs operating PDCCH monitoring X slots. The UE further monitors the selected search space slot or slots for a control channel of the Pcell, and/or the Scell. For example, a method performed by a UE for monitoring a control channel in a wireless communication network.

According to another aspect the object is achieved by providing a method performed by a radio network node for handling communication in a wireless communication network. The radio network node transmits configuration to a UE for monitoring, for a Pcell and/or a Scell, a search space slot within a slot group wherein the slot group is arranged in an X-slot group pattern, wherein the slot group is of a size of X-slots, and the X-slot group pattern is fixed relative to a reference time location and common for UEs operating physical downlink control channel, PDCCH, monitoring X slots. For example, a method performed by a radio network node for handling monitoring of a control channel in a wireless communication network. The configuration may comprise a period in terms of number of slot groups; an offset in terms of number of slot groups within the period; a duration in terms of number of slot groups within the period, and an indication of symbol with a slot. Furthermore, the configuration may comprise a deciding indication for the UE to select a search space slot according to any of the methods mentioned herein.

According to still another aspect the object is achieved by providing a UE and a radio network node configured to perform the methods herein.

Thus, it is herein provided a UE for handling communication in a wireless communication network. The UE is configured to select for a Pcell and/or a Scell, a search space slot within a slot group wherein the slot group is arranged in an X-slot group pattern, wherein the slot group is of a size of X-slots, and the X-slot group pattern is fixed relative to a reference time location and common for UEs operating PDCCH monitoring X slots. The UE is further configured to monitor the selected search space slot or slots for a control channel of the Pcell, and/or the Scell.

It is also herein provided a radio network node for handling communication in a wireless communication network. The radio network node is configured to transmit configuration to a UE for monitoring, for a Pcell and/or a Scell, a search space slot within a slot group wherein the slot group is arranged in an X-slot group pattern, wherein the slot group is of a size of X-slots, and the X-slot group pattern is fixed relative to a reference time location and common for UEs operating physical downlink control channel, PDCCH, monitoring X slots.

It is furthermore provided herein a computer program product comprising instructions, which, when executed on at least one processor, cause the at least one processor to carry out any of the methods above, as performed by the UE and radio network node, respectively. It is additionally provided herein a computer-readable storage medium, having stored thereon a computer program product comprising instructions which, when executed on at least one processor, cause the at least one processor to carry out the method according to any of the methods above, as performed by the UE or the radio network node, respectively.

The herein proposed embodiments allow UE energy saving by supporting small Y values and mobility-induced spatial QCL, or TCI state, changes, and simultaneously allow network flexibility to stagger UE specific search spaces in different slots, resulting in an improved performance of the wireless communication network.

### BRIEF DESCRIPTION OF THE DRAWINGS

Embodiments will now be described in more detail in relation to the enclosed drawings, in which:

FIG. 1 shows a basic transmitter block diagram for NR according to prior art;

FIG. 2 shows a time-frequency grid for 15 kHz sub-carrier spacing numerology according to prior art;

FIG. 3 shows a case where a UE is configured to monitor PDCCH candidates according to prior art;

FIG. 4 shows an illustrative case where a UE monitors beams according to prior art;

FIG. 5a shows a schematic overview depicting a communication network according to embodiments herein;

FIG. 5b shows a schematic flowchart depicting a method performed by a UE according to embodiments herein;

FIG. 5c shows a schematic flowchart depicting a method performed by a radio network node according to embodiments herein;

FIG. 6 shows a schematic overview depicting search space according to some embodiments herein;

FIG. 7 shows a schematic overview depicting search space according to some embodiments herein;

FIG. 8 shows a schematic overview depicting search space according to some embodiments herein;

FIG. 9 shows a schematic overview depicting search space according to some embodiments herein;

FIG. 10 shows a schematic overview depicting search space according to some embodiments herein;

FIG. 11 shows a schematic overview depicting search space according to some embodiments herein;

FIG. 12 shows a schematic overview depicting search space according to some embodiments herein;

FIG. 13 shows a schematic overview depicting search space according to some embodiments herein;

FIG. 14 shows a schematic overview depicting search space according to some embodiments herein;

FIG. 15 shows a schematic overview depicting search space according to some embodiments herein;

FIG. 16 shows a schematic overview depicting search space according to some embodiments herein;

FIG. 17 shows a combined flowchart and signalling scheme according to embodiments herein;

FIGS. 18a-18b show block diagrams depicting a UE according to embodiments herein;

FIGS. 19a-19b show block diagrams depicting a radio network node according to embodiments herein;

FIG. 20 illustrates a telecommunication network connected via an intermediate network to a host computer in accordance with some embodiments;

FIG. 21 illustrates a host computer communicating via a base station with a user equipment over a partially wireless connection in accordance with some embodiments;

FIG. 22 illustrates methods implemented in a communication system including a host computer, a base station, and a user equipment in accordance with some embodiments;

FIG. 23 illustrates methods implemented in a communication system including a host computer, a base station, and a user equipment in accordance with some embodiments;

FIG. 24 illustrates methods implemented in a communication system including a host computer, a base station, and a user equipment in accordance with some embodiments; and

FIG. 25 illustrates methods implemented in a communication system including a host computer, a base station, and a user equipment in accordance with some embodiments.

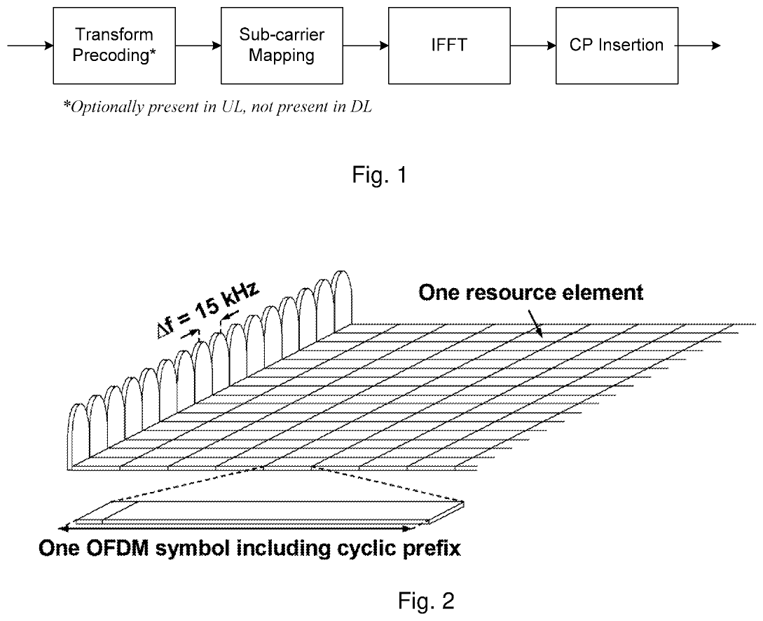

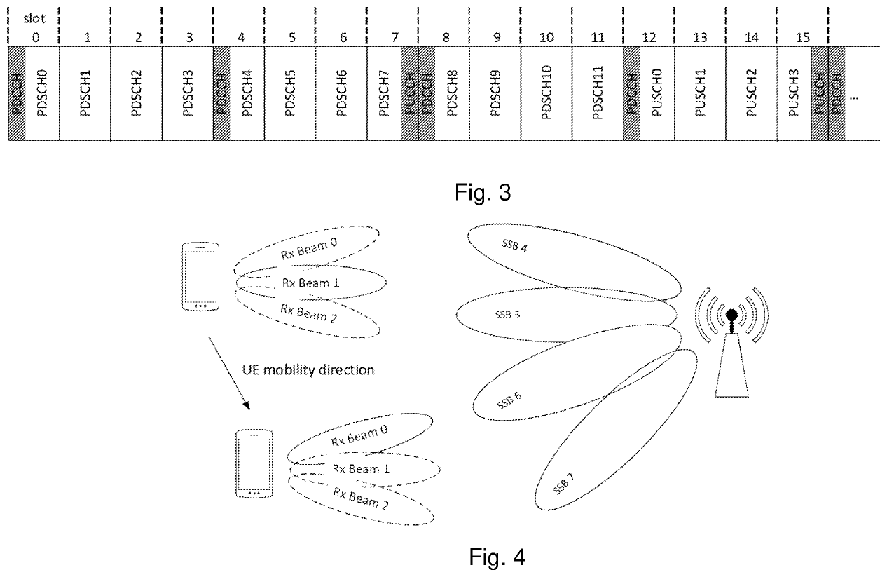

### DETAILED DESCRIPTION

Embodiments herein are described within the context of 3GPP NR radio technology (3GPP TS 38.300 V15.2.0 (2018-06)). It is understood, that the problems and solutions described herein are equally applicable to wireless access networks and user-equipments (UEs) implementing other access technologies and standards. NR is used as an example technology where embodiments are suitable, and using NR in the description therefore is particularly useful for understanding the problem and solutions solving the problem. In particular, embodiments are applicable also to 3GPP LTE, or 3GPP LTE and NR integration, also denoted as non-standalone NR.

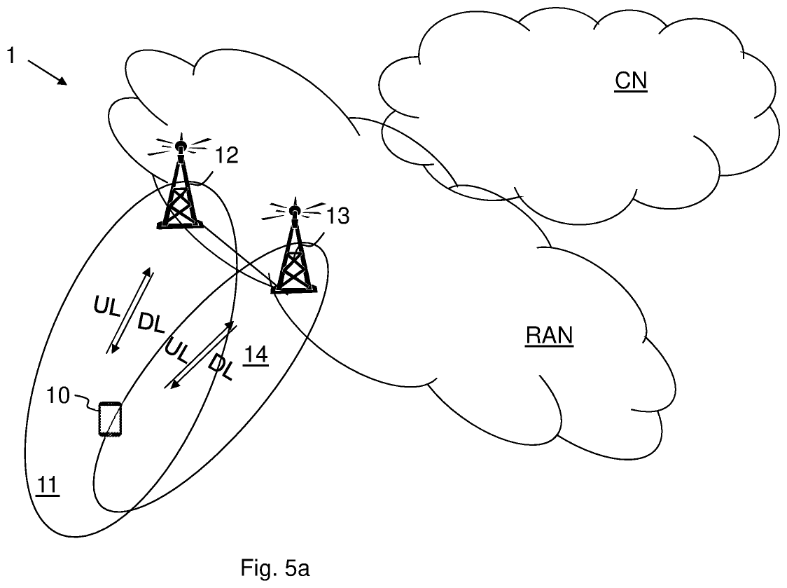

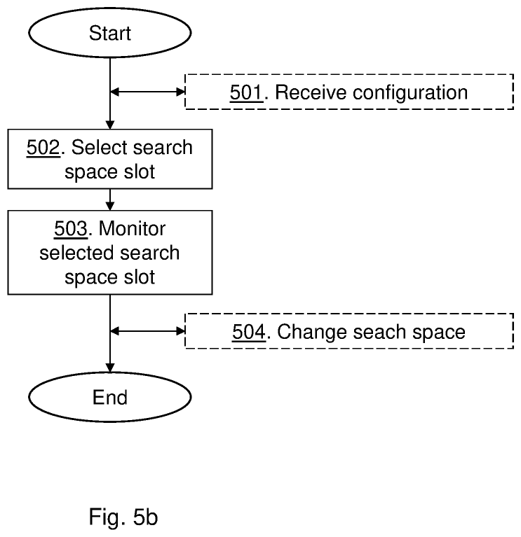

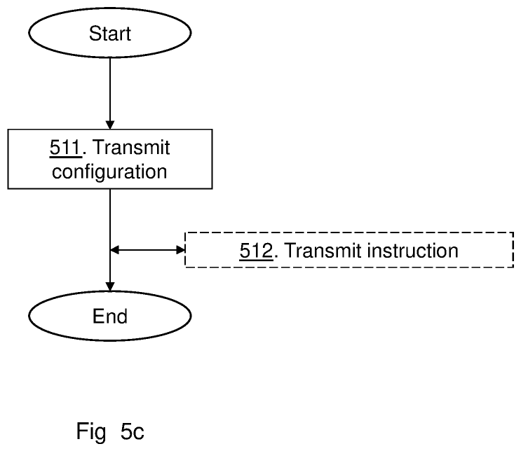

Embodiments herein relate to wireless communication networks in general. FIG. 5a is a schematic overview depicting a wireless communication network 1. The wireless communication network 1 comprises one or more RANs and one or more CNs. The wireless communication network 1 may use one or a number of different technologies, such as Wi-Fi, Long Term Evolution (LTE), LTE-Advanced, Fifth Generation (5G), Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in a 5G context, however, embodiments are also applicable in further development of the existing wireless communication systems such as e.g. WCDMA and LTE.

In the wireless communication network 1, wireless devices, e.g., a UE 10 such as a mobile station, a non-access point (non-AP) STA, a STA, a user equipment and/or a wireless terminal, communicate via one or more Access Networks (AN), e.g. RAN, to one or more core networks (CN). It should be understood by the skilled in the art that “UE” is a non-limiting term which means any terminal, wireless communication terminal, user equipment, internet of things (IoT) capable device, Machine Type Communication (MTC) device, Device to Device (D2D) terminal, or node e.g. smart phone, laptop, mobile phone, sensor, relay, mobile tablets or even a small base station capable of communicating using radio communication with a network node within an area served by the network node.

The wireless communication network 1 comprises a first radio network node 12 providing radio coverage over a geographical area, a first service area 11, of a radio access technology (RAT), such as LTE, Wi-Fi, WiMAX or similar. The first radio network node 12 may be a transmission and reception point e.g. a radio network node such as a Wireless Local Area Network (WLAN) access point or an Access Point Station (AP STA), an access node, an access controller, a base station, e.g. a radio base station such as a NodeB, an evolved Node B (eNB, eNode B), a gNodeB (gNB), a base transceiver station, a radio remote unit, an Access Point Base Station, a base station router, a transmission arrangement of a radio base station, a stand-alone access point or any other network unit or node capable of communicating with a UE within the area served by the first radio network node 12 depending e.g. on the radio access technology and terminology used. The first radio network node 12 may alternatively or additionally be a controller node or a packet processing node such as a radio controller node or similar. The first radio network node 12 may be referred to as the radio network node or as a serving network node wherein the first cell may be referred to as a serving cell or primary cell, and the serving network node communicates with the UE 10 in form of DL transmissions to the UE 10 and UL transmissions from the UE 10.

The wireless communication network 1 comprises a second radio network node 13 providing radio coverage over a geographical area, a second service area 14, of a radio access technology (RAT), such as LTE, Wi-Fi, WiMAX or similar. The second radio network node 13 may be a transmission and reception point e.g. a radio network node such as a Wireless Local Area Network (WLAN) access point or an Access Point Station (AP STA), an access node, an access controller, a base station, e.g. a radio base station such as a NodeB, an evolved Node B (eNB, eNode B), a gNodeB (gNB), a base transceiver station, a radio remote unit, an Access Point Base Station, a base station router, a transmission arrangement of a radio base station, a stand-alone access point or any other network unit or node capable of communicating with a UE within the area served by the second radio network node 13 depending e.g. on the radio access technology and terminology used. The second radio network node 13 may alternatively or additionally be a controller node or a packet processing node such as a radio controller node or similar. The second radio network node 13 may be referred to as a secondary serving network node, or secondary network node, wherein the second service area may be referred to as a secondary serving cell or secondary cell, and the secondary serving network node communicates with the UE 10 in form of DL transmissions to the UE 10 and UL transmissions from the UE 10.

It should be noted that a service area may be denoted as cell, beam, beam group or similar to define an area of radio coverage.

According to embodiments herein methods allow UE energy saving by supporting small Y values and mobility-induced spatial QCL, or TCI state, changes, and simultaneously allow network flexibility to stagger UE specific search spaces in different slots.

### Disclaimer:

For the proposed solution, the following is considered:
A radio network node such as a RAN node, which can be any of gNB, eNB, en-gNB, ng-eNB, gNB-CU, gNB-CU-CP, eNB-CU, eNB-CU-CP.
A UE such as a terminal equipment, which supports any of E-UTRAN, NR, MR-DC, e.g., such as EN-DC, NE-DC, NR-DC.

Note that in a general scenario the term “radio network node” can be substituted with “transmission point”. Distinction between the transmission points (TPs) may typically be based on cell specific reference signals or different synchronization signals transmitted. Several TPs may be logically connected to the same radio network node but if they are geographically separated, or are pointing in different propagation directions, the TPs may be subject to the same mobility issues as different radio network nodes. In subsequent sections, the terms “radio network node” and “TP” can be thought of as interchangeable.

The method actions performed by the UE 10 for handling communication in the wireless communication network 1 according to embodiments will now be described with reference to a flowchart depicted in FIG. 5b. The actions do not have to be taken in the order stated below but may be taken in any suitable order. Dashed boxes indicate optional features.

Action 501. The UE 10 may receive a configuration from a radio network node such as the first radio network node 12 or the second radio network node 13. The configuration may comprise a period in terms of number of slot groups; an offset in terms of number of slot groups within the period; a duration in terms of number of slot groups within the period, and an indication of symbol within a slot. The configuration may further comprise a deciding indication indicating a method to use to select search space slot.

Action 502. The UE 10 selects for a Pcell and/or a Scell, a search space slot within a slot group wherein the slot group is arranged in an X-slot group pattern, wherein the slot group is of a size of X-slots, and the X-slot group pattern is fixed relative to a reference time location and common for UEs operating PDCCH monitoring X slots. The UE 10 may select the search space slot by determining a search space monitoring slot within an X-slot group based on a location of a first slot of a type0 CSS monitoring occasion for the PCell, a PSCell and/or the SCell within a slot group. Alternatively, the UE 10 may select the search space slot by determining a slot group grid offset for a SCell based on at least a slot index of a first slot of a type0 CSS monitoring occasion on the PCell or primary secondary cell, PSCell.

Action 503. The UE 10 monitors the selected search space slot or slots for a control channel of the Pcell, and/or the Scell.

Action 504. The UE 10 may change search space in response to receiving an instruction from a radio network node to change search space, or by autonomously determining a new type0 PDCCH monitoring location during a random access procedure.

The method actions performed by the radio network node, such as the first radio network node 12 or the second radio network node 13, for handling communication in the wireless communication network 1 according to embodiments will now be described with reference to a flowchart depicted in FIG. 5c. The actions do not have to be taken in the order stated below but may be taken in any suitable order. Dashed boxes indicate optional features.

Action 511. The radio network node transmits configuration to the UE 10 for monitoring, for a Pcell, and/or a Scell, the search space slot within the slot group wherein the slot group is arranged in the X-slot group pattern, wherein the slot group is of a size of X-slots, and the X-slot group pattern is fixed relative to the reference time location and common for UEs operating PDCCH monitoring X slots. The configuration may comprise the period in terms of number of slot groups; the offset in terms of number of slot groups within the period; the duration in terms of number of slot groups within the period, and the indication of symbol within a slot. The configuration may further comprise the deciding indication indicating the method to use to select search space slot.

Action 512. The radio network node may further transmit an instruction to the UE 10 to change search space.

Below are described different ways to select the search space slot within a slot group.

### Embodiment Group A—Common Fixed Pattern of X-Slot Groups.

For a given X slot group size, the X-slot group pattern is fixed relative to a reference time location and common for all UEs operating PDCCH monitoring every X slots. For example, the X-slot group starts from the first slot in an even indexed radio frame.

The UE 10 receives a search space configuration from the radio network node for
period in terms of X-slot groups
offset in terms of X-slot groups within the period
duration in terms of X-slot groups within the period
monitoringSymbolsWithinSlot.

### Embodiment Group B—UE-Specific Fixed Pattern of X-Slot Groups

The UE determines the start of a X-slot group based on the location of the first slot of the type0 CSS monitoring occasions (denoted by n₀ in the current NR system specs).

The UE 10 receives a search space configuration from the radio network node for
period in terms of X-slot groups
offset in terms of X-slot groups within the period
duration in terms of X-slot groups within the period
monitoringSymbolsWithinSlot
   Embodiments herein thus disclose:

### Embodiment Group A—Common Fixed Pattern of X-Slot Groups

For a given X slot group size, the X-slot group pattern is fixed relative to a reference time location and common for all UEs operating PDCCH monitoring every X slots. For example, the X-slot group starts from the first slot in an even indexed radio frame.
The UE 10 receives a search space configuration from a network node for
period in terms of X-slot groups
offset in terms of X-slot groups within the period
duration in terms of X-slot groups within the period
monitoringSymbolsWithinSlot

### Embodiments for a PCell or PSCell.

The UE 10 determines the search space monitoring slot within an X-slot group (denoted as the monitoringSlotWithinSlotGroup) based on the location of the first slot of the type0 CSS monitoring occasions (denoted by n₀ in the current NR system specs) within a slot group. As one nonlimiting embodiment, the UE determines

monitoringSlotWithinSlotGroup=n₀ modulo X
where n₀, as described in Section 0, is determined based on the current NR system specs.

The UE 10 determines the slot indices to monitor the configured search space as follows:

(period*p+offset+y)*X+monitoringSlotWithinSlotGroup
where y=0, 1, . . . , duration−1 and p=0, 1, 2, . . . . The monitoringSymbolsWithinSlot parameter is applied to each of the monitoring slot(s) to determine which symbols within the slot to monitor according to the current NR specs.

When the UE 10 receives instruction from the radio network node to change the type0 PDCCH monitoring location(s) (i.e., change in no), the UE 10 determines a new value for monitoringSlotWithinSlotGroup according to the new type0 PDCCH monitoring location(s) and determines the slot indices to monitor all search spaces according to the new monitoringSlotWithinSlotGroup.

As a nonlimiting exemplary embodiment, the UE 10 receives a search space configuration from the radio network node for the case X=4:
period of 5 X-slot groups
offset of 1 X-slot group within the period
duration 2 X-slot groups within the period

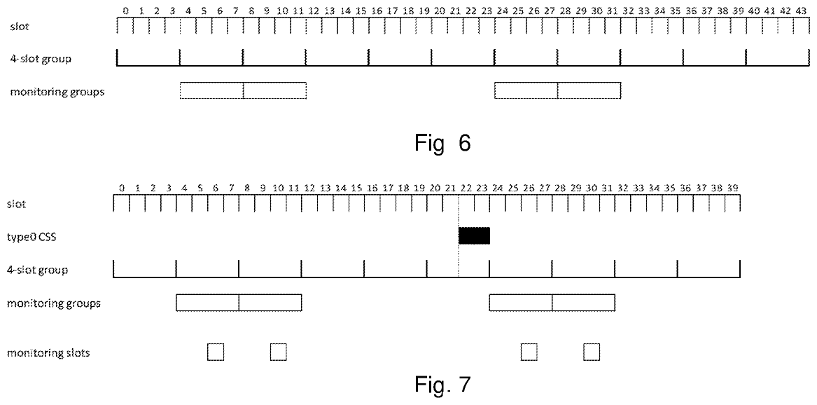

The X-slot groups that will contain the search space monitoring occasions as illustrated in FIG. 6.

FIG. 6 is an illustrative search space configuration of X=4 and periodicity of 5 X-slot groups, offset of 1 X-slot group and duration of 2 X-slot groups.

Furthermore, suppose the first slot of the type0 CSS monitoring occasions is n₀=22. The UE 10 thus determines
monitoringSlotWithinSlotGroup=22 modulo 4=2.

This monitoringSlotWithinSlotGroup is then applied to the configured search space as illustrated in FIG. 7, which are calculated as

(5*p+1+y)*4+2 for y=0,1 and p=0,1,2 . . . .

FIG. 7 is an illustrative search space configuration of X=4 and periodicity of 5 X-slot groups, offset of 1 X-slot group and duration of 2 X-slot groups.

Finally, the configured monitoringSymbolsWithinSlot is applied to the determined monitoring slots for the configured search space.

As an extension to the above embodiment, the UE 10 receives an extraSlotOffsetWithinSlotGroup parameter in addition to the search space configuration listed above. The UE 10 determines the slot indices to monitor the configured search space as follows:

(period*p+offset+y)*X+monitoringSlotWithinSlotGroup+extraSlotOffsetWithinSlotGroup
where y=0, 1, . . . , duration−1 and p=0, 1, 2, . . . .

Alternatively, the UE 10 determines the slot indices to monitor the configured search space as follows:

(period*p+offset+y)*X+((monitoringSlotWithinSlotGroup+extraSlotOffsetWithinSlotGroup)modulo X)
where y=0, 1, . . . , duration−1 and p=0, 1, 2, . . . .

Another alternative is for the UE 10 to determine the slot indices to monitor the configured search space as follows:

(period*p+offset+y)*X+((no+extraSlotOffsetWithinSlotGroup)modulo X)
where y=0, 1, . . . , duration−1 and p=0, 1, 2, . . . .

Embodiments for cases where the multi-slot PDCCH monitoring is not used for PCell/PSCell.

For the carrier aggregation/dual connectivity cases where multi-slot PDCCH monitoring is not used for the PCell or PSCell, then all the cells with multi-slot PDCCH monitoring are SCells. For these cases, monitoringSlotWithinSlotGroup is set to 0 for applying the above embodiments to the monitoring occasion determination for search spaces for the SCells.

Embodiments for cases where the multi-slot PDCCH monitoring is used for PCell/PSCell and SCells.

For the general case, the UE 10 determines monitoringSlotWithinSlotGroup for the SCell based on at least the slot index of the first slot of the type0 CSS monitoring occasions (denoted by n₀ in the current NR system specs) on the PCell/PSCell as follows:

monitoringSlotWithinSlotGroup=floor(n₀×2^{μ}^{ₛ}^{-μ}^{ₚ})modulo Xₛ,
where
floor(x) is a function returning an integer no greater than the input variable x;
n₀ is the slot index of the first slot of the type0 CSS monitoring occasions on the PCell/PSCell;
μₛ is the SCell numerology;
μₚ, is the PCell/PSCell numerology;
Xₛ is the slot group size for the SCell.

Further elaboration, examples and variations of the above embodiment and teaching are presented in the following sections.

As another nonlimiting exemplary embodiment, the UE 10 determines monitoringSlotWithinSlotGroup for the SCell as follows:

monitoringSlotWithinSlotGroup=ceil(n₀×2^{μ}^{ₛ}^{-μ}^{ₚ})modulo Xₛ,
where ceil(x) is a function returning an integer no smaller than the input variable x.

Embodiments for cases where the PCell/PSCell and the SCell have the same numerology.

When multi-slot PDCCH monitoring of the same group size is used for the PCell/PSCell and the SCell having the same numerology, the monitoringSlotWithinSlotGroup calculated for the PCell/PSCell using the first slot of the type0 CSS monitoring occasions (denoted by n₀ in the current NR system specs) on the PCell/PSCell is applied to the SCell for determining monitoring occasions for search spaces on the SCell. This is because μₛ−μₚ=0 and Xₛ=Xₚ such that, for the SCell,

monitoringSlotWithinSlotGroup=floor(n₀×2⁰)modulo Xₛ=n₀ modulo Xₚ.

As a nonlimiting exemplary embodiment, the UE 10 receives a search space configuration from a network node for the SCell and with the case X=4:
period of 5 X-slot groups
offset of 1 X-slot group within the period
duration 2 X-slot groups within the period

Furthermore, suppose the first slot of the type0 CSS monitoring occasions on the PCell/PSCell is n₀=18. The UE 10 thus determines

monitoringSlotWithinSlotGroup=18 modulo 4=2.

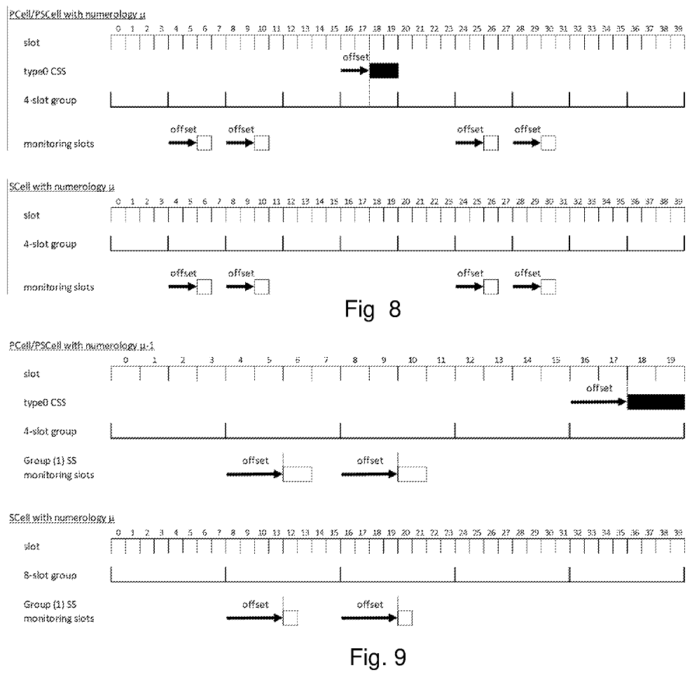

This monitoringSlotWithinSlotGroup is then applied to the configured search space for the SCell as illustrated in FIG. 8, which are calculated as

(5*p+1+y)*4+2 for y=0,1 and p=0,1,2 . . . .

FIG. 8 illustrates search space configuration of X=4 and periodicity of 5 X-slot groups, offset of 1 X-slot group and duration of 2 X-slot groups for the SCell having the same numerology with the PCell/PSCell numerology.

Embodiments for cases where the PCell/PSCell numerology is smaller than and the SCell numerology.

When the PCell/PSCell numerology (denoted by μₚ) is smaller than the SCell numerology (denoted by μₛ), a slot duration on the PCell/PSCell is longer than the slot duration on the SCell as illustrated in FIG. 9.

To enable UE power saving, it's desirable to align the PDCCH monitoring occasions across the different serving cells and reduce the time the UE 10 needs to power up electronics for PDCCH monitoring. It is therefore beneficial to using a large slot group size X for a serving cell with larger numerology. As a nonlimiting embodiment, X=4 is used for a PCell/PSCell with 480 kHz SCS (which is μₚ=5) and X=8 is used for a SCell with 960 kHz SCS (which is μₛ=6). Such numerology-dependent slot group size configuration enables the slot groups across different serving cells with different numerologies to be aligned as illustrated in FIG. 9.

For the case where the SCell numerology (denoted by μₛ) is one level larger than the PCell/PSCell numerology (denoted by μₚ) and SCell slot group size (denoted by Xₛ) is twice of PCell/PSCell slot group size (denoted by Xₚ), the UE 10 can determine monitoringSlotWithinSlotGroup for the SCell as two times the monitoringSlotWithinSlotGroup determined for the PCell/PSCell:

monitoringSlotWithinSlotGroups=2*monitoringSlotWithinSlotGroupp

For the general case, the UE 10 can determine monitoringSlotWithinSlotGroup for the SCell from the index of the first slot of the type0 CSS monitoring occasions (denoted by n₀ in the current NR system specs) on the PCell/PSCell as follows:

monitoringSlotWithinSlotGroups=(n₀×2^{μ}^{ₛ}^{-μ}^{ₚ})modulo Xₛ,
which is because 2^{μ}^{ₛ}^{-μ}^{ₚ} is an integer greater than one such that the floor function is not needed.

For the general case, the UE 10 can determine monitoringSlotWithinSlotGroup for the SCell from the monitoringSlotWithinSlotGroup determined for the PCell/PSCell as follows:

monitoringSlotWithinSlotGroups=(monitoringSlotWithinSlotGroupp×2^{μ}^{ₛ}^{-μ}^{ₚ})modulo Xₛ

For the general case, the UE 10 may also determine monitoringSlotWithinSlotGroup for the SCell from the index of the first slot of the type0 CSS monitoring occasions (denoted by n₀ in the current NR system specs) on the PCell/PSCell as follows:

$$monitoringSlotWithinSlotGroups = ( ( {n}_{0} modulo {X}_{p} ) \times {2}^{{μ}_{s} - {μ}_{p}} ) modulo {X}_{S}$$

As a nonlimiting exemplary embodiment for the case where PCell/PSCell numerology is μ−1, the PCell/PSCell slot group size X=4, and the SCell numerology is μ, the UE 10 receives a search space configuration from a network node for the SCell and with the case X=8:
period of 5 X-slot groups
offset of 1 X-slot group within the period
duration 2 X-slot groups within the period

Furthermore, suppose the first slot of the type0 CSS monitoring occasions on the PCell/PSCell is n₀=18. The UE 10 determines the monitoringSlotWithinSlotGroup for the PCell/PSCell as

monitoringSlotWithinSlotGroupp=18 modulo 4=2.

The UE 10 determines the monitoringSlotWithinSlotGroup for the SCell as

monitoringSlotWithinSlotGroups=2*monitoringSlotWithinSlotGroupp=4

Alternatively, the UE can determine the monitoringSlotWithinSlotGroup for the SCell as

$$m onitoringSlotWithinSlotGroups = ( 18 \times {2}^{μ - ( μ - 1 )} ) modulo 8 = 4 ,$$

which, as expected, results in the same monitoringSlotWithinSlotGroups.

This monitoringSlotWithinSlotGroups is then applied to the configured search space as illustrated in FIG. 8, which are calculated as

(5*p+1+y)*8+4 for y=0,1 and p=0,1,2 . . . .

FIG. 9 is illustrating search space configuration of X=8 and periodicity of 5 X-slot groups, offset of 1 X-slot group and duration of 2 X-slot groups for the SCell having a larger numerology than the PCell/PSCell numerology.

As another nonlimiting exemplary embodiment for the case where PCell/PSCell numerology is μ−1, the PCell/PSCell slot group size X=4, and the SCell numerology is μ, the UE 10 receives a search space configuration from a network node for the SCell and with the case X=4:
period of 5 X-slot groups
offset of 1 X-slot group within the period
duration 2 X-slot groups within the period

Furthermore, suppose the first slot of the type0 CSS monitoring occasions on the PCell/PSCell is n₀=18. As described in the above, the UE 10 determines monitoringSlotWithinSlotGroupp=2. The UE 10 determines the monitoringSlotWithinSlotGroup for the SCell as

monitoringSlotWithinSlotGroups=(2×2^{μ-(μ-1)})modulo 4=0.

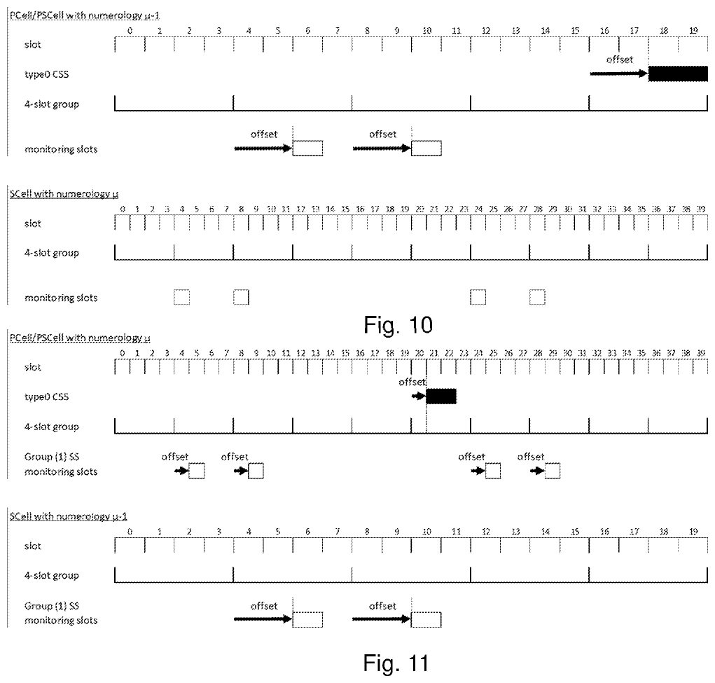

That is, for this example, the monitoring occasions of the configured search space on the SCell with X=4 is at the beginning of the slot groups as illustrated in FIG. 10.

FIG. 10 is illustrating search space configuration of X=4 and periodicity of 5 X-slot groups, offset of 1 X-slot group and duration of 2 X-slot groups for the SCell having a larger numerology than the PCell/PSCell numerology.

Embodiments for cases where the PCell/PSCell numerology is larger than and the SCell numerology.

When the PCell/PSCell numerology (denoted by μₚ) is larger than the SCell numerology (denoted by μₛ), a slot duration on the PCell/PSCell is shorter than the slot duration on the SCell as illustrated in FIG. 11.

For the general case, the UE 10 can determine monitoringSlotWithinSlotGroup for the SCell from the index of the first slot of the type0 CSS monitoring occasions (denoted by n₀ in the current NR system specs) on the PCell/PSCell as follows:

monitoringSlotWithinSlotGroups=floor(n₀×2^{μ}^{ₛ}^{-μ}^{ₚ})modulo Xₛ,
where floor(x) is function returning an integer no greater than the input variable x.

As a nonlimiting exemplary embodiment, the UE 10 receives a search space configuration from a network node for the SCell and with the case X=4:
period of 5 X-slot groups
offset of 1 X-slot group within the period
duration 2 X-slot groups within the period

Furthermore, suppose the first slot of the type0 CSS monitoring occasions on the Pcell/PSCell is n₀=21. The UE 10 thus determines for the SCell

monitoringSlotWithinSlotGroups=floor(21×2^{(μ-1)-μ})modulo 4=10 modulo 4=2.

This monitoringSlotWithinSlotGroup is then applied to the configured search space for the SCell as illustrated in FIG. 11, which are calculated as

(5*p+1+y)*4+2 for y=0,1 and p=0,1,2 . . . .

FIG. 11 is illustrating search space configuration of X=4 and periodicity of 5 X-slot groups, offset of 1 X-slot group and duration of 2 X-slot groups for the SCell having a smaller numerology than the PCell/PSCell numerology.

### Embodiment Group B—UE-Specific Fixed Pattern of X-Slot Groups

The UE 10 determines the start of a X-slot group based on the location of the first slot of the type0 CSS monitoring occasions (denoted by n₀ in the current NR system specs).

The UE 10 receives a search space configuration from the radio network node for
period in terms of X-slot groups
offset in terms of X-slot groups within the period
duration in terms of X-slot groups within the period
monitoringSymbolsWithinSlot

### Embodiments for a PCell or PSCell

The UE 10 determines the start of a X-slot group based on the location of the first slot of the type0 CSS monitoring occasions (denoted by n₀ in the current NR system specs) such that the first slot of the type0 CSS monitoring occasions is also a first slot of a slot group. That is, a X-slot group consists of the X consecutive slots starting from a slot with index n:

$$n = X * p + ( {n}_{0} modulo X )$$

where p=0, 1, 2, . . . .

To simply the notation and presentation, a slot group grid offset is defined as

n_{0,X}=n₀ modulo X.

That is, a X-slot group consists of the X consecutive slots starting from a slot with index n:

$$n = X * p + {n}_{0 , X}$$

where p=0, 1, 2, . . . .

The search space monitoring slot within a X-slot group is always at the beginning of a X-slot group (i.e., monitoringSlotWithinSlotGroup=0). The UE 10 determines the slot indices to monitor the configured search space as follows:

$$( period * p + offset + y ) * X + {n}_{0 , X}$$

where y=0, 1, . . . , duration−1 and p=0, 1, 2, . . . . The monitoringSymbolsWithinSlot parameter is applied to each monitoring slots according the current NR specs.

When the UE 10 receives instruction from the radio network node to change the type0 PDCCH monitoring location(s), the UE 10 determines slot indices to monitor for all search spaces according to the new first slot of the type0 CSS monitoring occasions (denoted by n₀ in the current NR system specs).

In one variation of the embodiment the instruction from the radio network node can be a MAC-CE activation of a new TCI state, where the TCI state is either configured with the ID of an SS/PBCH block or is configured with the ID of a channel state information reference signal (CSI-RS) that is quasi co-located (QCL'd) with an SS/PBCH block.

In another variation, rather than receiving an explicit instruction from the radio network node to change the type0 PDCCH monitoring location the UE 10 autonomously determines a new type0 PDCCH monitoring location during a random access procedure (RACH). In this variation, the UE 10 determines a new value of n₀ based on a preferred SS/PBCH block detected by the UE 10 which is associated with a random access occasion (RO) used by the UE 10 during the RACH procedure.

As a nonlimiting exemplary embodiment, the UE 10 receives a search space configuration from a network node for the case X=4:
period of 5 X-slot groups
offset of 1 X-slot group within the period
duration 2 X-slot groups within the period

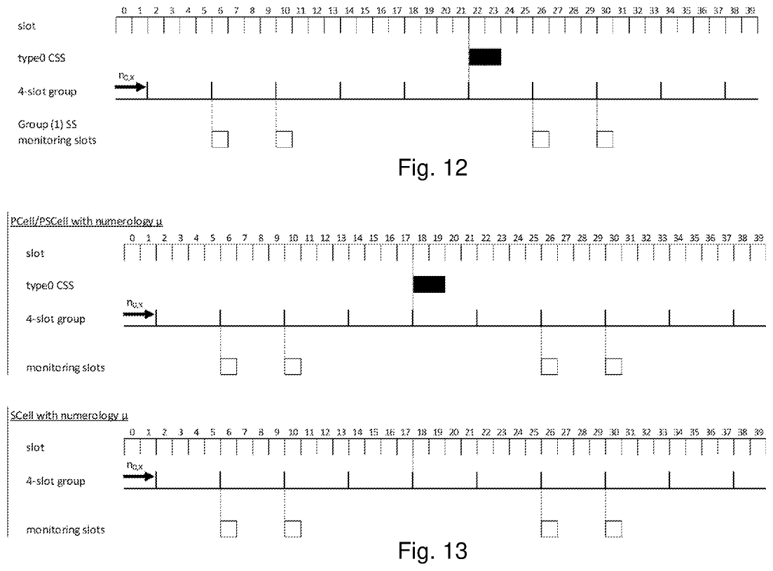

Furthermore, suppose the first slot of the type0 CSS monitoring occasions is n₀=22. The X-slot groups that will contain the search space monitoring occasions and the slots to be monitored for the configured search space are as illustrated in FIG. 12 where the start of the first slot group is aligned with slot 22 modulo 4=2.

FIG. 12 is illustrating search space configuration of X=4 and periodicity of 5 X-slot groups, offset of 1 X-slot group and duration of 2 X-slot groups.

As an extension to embodiments, the UE 10 receives an extraSlotOffsetWithinSlotGroup parameter in addition to the other search space configuration as above.

The UE 10 determines the slot indices to monitor the configured search space as follows:

(period*p+offset+y)*X+n_{0,X}+extraSlotOffsetWithinSlotGroup
where y=0, 1, . . . , duration−1 and p=0, 1, 2, . . . .

Alternatively, the UE 10 determines the slot indices to monitor the configured search space as follows:

$$( period * p + offset + y ) * X + ( ( {n}_{0} + extraSlotOffsetWithinSlotGroup ) modulo X )$$

where y=0, 1, . . . , duration−1 and p=0, 1, 2, . . . .

Embodiments for cases where the multi-slot PDCCH monitoring is not used for PCell/PSCell.

For the carrier aggregation/dual connectivity cases where multi-slot PDCCH monitoring is not used for the PCell or PSCell, then all the cells with multi-slot PDCCH monitoring are SCells. For these cases, the slot group is aligned with the frame or the subframe of the NR serving cell. That is, a X-slot group consists of the X consecutive slots starting from a slot with index n:

$$n = X * p$$

where p=0, 1, 2, . . . . An alternative description of this is using the same X-slot starting slot calculation as the above embodiments with n₀=0. A further description of this is that the slot group grid offset n_{0,X}=0.

Embodiments for cases where the multi-slot PDCCH monitoring is used for PCell/PSCell and SCells.

For the general case, the UE 10 determines the slot group grid offset for the SCell based on at least the slot index of the first slot of the type0 CSS monitoring occasions (denoted by n₀ in the current NR system specs) on the PCell/PSCell as follows:

$${n}_{0 , {X}_{s}} = floor ( {n}_{0} \times {2}^{{μ}_{s} - {μ}_{p}} ) modulo {X}_{S} ,$$

where
floor(x) is a function returning an integer no greater than the input variable x;
n₀ is the slot index of the first slot of the type0 CSS monitoring occasions on the PCell/PSCell;
μₛ is the SCell numerology;
μₚ is the PCell/PSCell numerology;
Xₛ is the slot group size for the SCell.

Further elaboration, examples and variations of the above main embodiment and teaching are presented in the following sections.

As another nonlimiting exemplary embodiment, the UE determines slot group grid offset for the SCell as follows:

$${n}_{0 , {X}_{s}} = ceil ( {n}_{0} \times {2}^{{μ}_{s} - {μ}_{p}} ) modulo {X}_{S} ,$$

where ceil(x) is a function returning an integer no smaller than the input variable x.

Embodiments for cases where the PCell/PSCell and the SCell have the same numerology.

When multi-slot PDCCH monitoring of the same group size is used for the PCell/PSCell and the SCell having the same numerology, the slot group grid offset calculated for the PCell/PSCell using the first slot of the type0 CSS monitoring occasions (denoted by n₀ in the current NR system specs) on the PCell/PSCell is applied to the SCell for determining monitoring occasions for search spaces on the SCell. This is because μₛ−μₚ=0 and Xₛ=Xₚ=X such that, for the SCell,

$${n}_{0 , X} = floor ( {n}_{0} \times {2}^{0} ) modulo {X}_{s} = {n}_{0} modulo X$$

As a nonlimiting exemplary embodiment, the UE 10 receives a search space configuration from a network node for the SCell and with the case X=4:
period of 5 X-slot groups
offset of 1 X-slot group within the period
duration 2 X-slot groups within the period

Furthermore, suppose the first slot of the type0 CSS monitoring occasions on the Pcell/PSCell is n₀=18. The UE 10 thus determines

n_{0,X}=18 modulo 4=2.

This is then applied to the configured search space for the SCell as illustrated in FIG. 13, which are calculated as

$$( 5 * p + 1 + y ) * 4 + 2 for y = 0 , 1 and p = 0 , 1 , 2 , … .$$

FIG. 13 is illustrating search space configuration of X=4 and periodicity of 5 X-slot groups, offset of 1 X-slot group and duration of 2 X-slot groups for the SCell having the same numerology with the PCell/PSCell numerology.

Embodiments for cases where the PCell/PSCell numerology is smaller than and the SCell numerology.

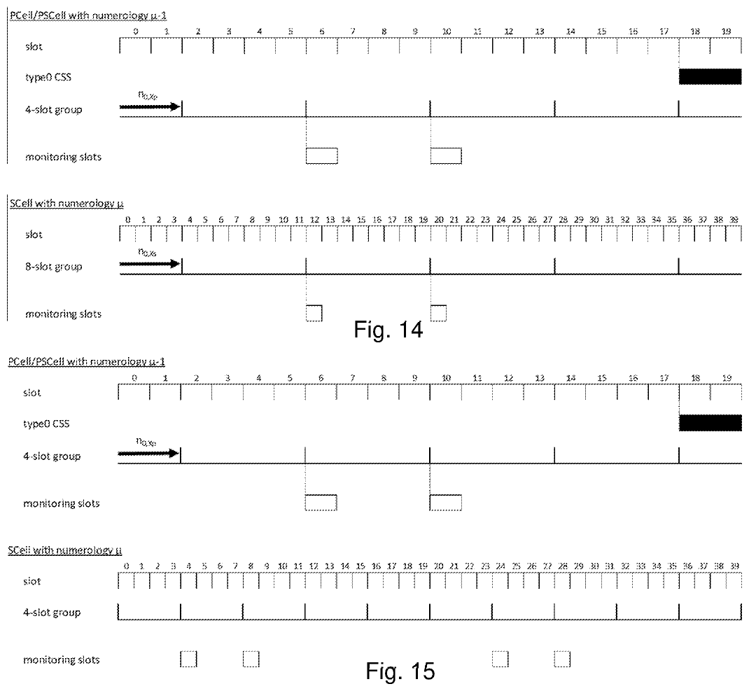

When the PCell/PSCell numerology (denoted by μₚ) is smaller than the SCell numerology (denoted by μₛ), a slot duration on the PCell/PSCell is longer than the slot duration on the SCell as illustrated in FIG. 14.

To enable UE power saving, it's desirable to align the PDCCH monitoring occasions across the different serving cells and reduce the two time the UE needs to power up electronics for PDCCH monitoring. It is therefore beneficial to using a large slot group size X for a serving cell with larger numerology. As a nonlimiting embodiment, X=4 is used for a PCell/PSCell with 480 kHz SCS (which is μₚ=5) and X=8 is used for a SCell with 960 kHz SCS (which is μₛ=6). Such numerology-dependent slot group size configuration enables the slot groups across different serving cells with different numerologies to be aligned as illustrated in FIG. 14.

For the case where the SCell numerology (denoted by μₛ) is one level larger than the PCell/PSCell numerology (denoted by μₚ) and SCell slot group size (denoted by Xₛ) is twice of PCell/PSCell slot group size (denoted by Xₚ), the UE can determine the slot group grid offset for the SCell as two times the slot group grid offset determined for the PCell/PSCell:

$${n}_{0 , {X}_{s}} = 2 * {n}_{0 , {X}_{p}}$$

For the general case, the UE 10 may determine the slot group grid offset for the SCell from the index of the first slot of the type0 CSS monitoring occasions (denoted by n₀ in the current NR system specs) on the PCell/PSCell as follows:

$${n}_{0 , {X}_{s}} = ( {n}_{0} \times {2}^{{μ}_{s} - {μ}_{p}} ) modulo {X}_{s} ,$$

which is because 2^{μ}^{ₛ}^{-μ}^{ₚ} is an integer greater than one such that the floor function is not needed.

For the general case, the UE 10 may determine the slot group grid offset for the SCell from the slot group grid offset determined for the PCell/PSCell as follows:

$${n}_{0 , {X}_{s}} = ( {n}_{0 , {X}_{p}} \times {2}^{{μ}_{s} - {μ}_{p}} ) modulo {X}_{s}$$

For the general case, the UE 10 may also determine the slot group grid offset for the SCell from the index of the first slot of the type0 CSS monitoring occasions (denoted by n₀ in the current NR system specs) on the PCell/PSCell as follows:

$${n}_{0 , {X}_{s}} = ( ( {n}_{0} modulo {X}_{p} ) \times {2}^{{μ}_{s} - {μ}_{p}} ) modulo {X}_{s}$$

As a nonlimiting exemplary embodiment for the case where PCell/PSCell numerology is μ−1, the PCell/PSCell slot group size X=4, and the SCell numerology is μ, the UE 10 receives a search space configuration from a network node for the SCell and with the case X=8:
period of 5 X-slot groups
offset of 1 X-slot group within the period
duration 2 X-slot groups within the period

Furthermore, suppose the first slot of the type0 CSS monitoring occasions on the PCell/PSCell is n₀=18. The UE 10 determines the slot group grid offset for the PCell/PSCell as

$${n}_{0 , {X}_{p}} = 18 modulo 4 = 2 .$$

The UE 10 determines the slot group grid offset for the SCell as

$${n}_{0 , {X}_{s}} = 2 * {n}_{0 , {X}_{p}} = 4 .$$

Alternatively, the UE 10 determines the slot group grid offset for the SCell as

n_{0,X}_{ₛ}=(18×2^{μ-(μ-1)})modulo 8=4,
which, as expected, results in the same slot group grid offset.

This is then applied to the configured search space as illustrated in FIG. 14, which are calculated as

$$( 5 * p + 1 + y ) * 8 + 4 for y = 0 , 1 and p = 0 , 1 , 2 , … .$$

FIG. 14 is illustrating search space configuration of X=8 and periodicity of 5 X-slot groups, offset of 1 X-slot group and duration of 2 X-slot groups for the SCell having a larger numerology than the PCell/PSCell numerology.

As another nonlimiting exemplary embodiment for the case where PCell/PSCell numerology is μ−1, the PCell/PSCell slot group size X=4, and the SCell numerology is μ, the UE 10 receives a search space configuration from a network node for the SCell and with the case X=4:
period of 5 X-slot groups
offset of 1 X-slot group within the period
duration 2 X-slot groups within the period

Furthermore, suppose the first slot of the type0 CSS monitoring occasions on the PCell/PSCell is n₀=18. As described in the above, the UE determines slot group grid offset for the PCell/PSCell as n_{0,X}_{ₚ}=2. The UE 10 determines the slot group grid offset for the SCell as

$${n}_{0 , {X}_{s}} = ( 2 \times {2}^{μ - ( μ - 1 )} ) modulo 4 = 0 .$$

That is, for this example, the monitoring occasions of the configured search space on the SCell with X=4 is at the beginning of the slot groups as illustrated in FIG. 15.

FIG. 15 is illustrating search space configuration of X=4 and periodicity of 5 X-slot groups, offset of 1 X-slot group and duration of 2 X-slot groups for the SCell having a larger numerology than the PCell/PSCell numerology.

Embodiments for cases where the PCell/PSCell numerology is larger than and the SCell numerology.

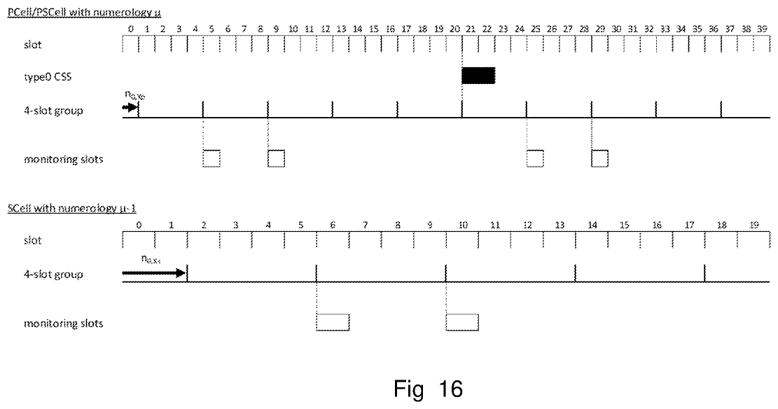

When the PCell/PSCell numerology (denoted by μₚ) is larger than the SCell numerology (denoted by μₛ), a slot duration on the PCell/PSCell is shorter than the slot duration on the SCell as illustrated in FIG. 16.

For the general case, the UE 10 may determine slot group grid offset for the SCell from the index of the first slot of the type0 CSS monitoring occasions (denoted by n₀ in the current NR system specs) on the PCell/PSCell as follows:

$${n}_{0 , {X}_{s}} = floor ( {n}_{0} \times {2}^{{μ}_{s} - {μ}_{p}} ) modulo {X}_{s} ,$$

where floor(x) is function returning an integer no greater than the input variable x.

As a nonlimiting exemplary embodiment, the UE 10 receives a search space configuration from a network node for the SCell and with the case X=4:
period of 5 X-slot groups
offset of 1 X-slot group within the period
duration 2 X-slot groups within the period

Furthermore, suppose the first slot of the type0 CSS monitoring occasions on the PCell/PSCell is n₀=21. The UE 10 thus determines for the SCell

$${n}_{0 , {X}_{s}} = floor ( 21 \times {2}^{( μ - 1 ) - μ} ) modulo 4 = 10 modulo 4 = 2 .$$

This is then applied to the configured search space for the SCell as illustrated in FIG. 16, which are calculated as

$$( 5 * p + 1 + y ) * 4 + 2 for y = 0 , 1 and p = 0 , 1 , 2 , … .$$

FIG. 16 is illustrating search space configuration of X=4 and periodicity of 5 X-slot groups, offset of 1 X-slot group and duration of 2 X-slot groups for the SCell having a smaller numerology than the PCell/PSCell numerology.

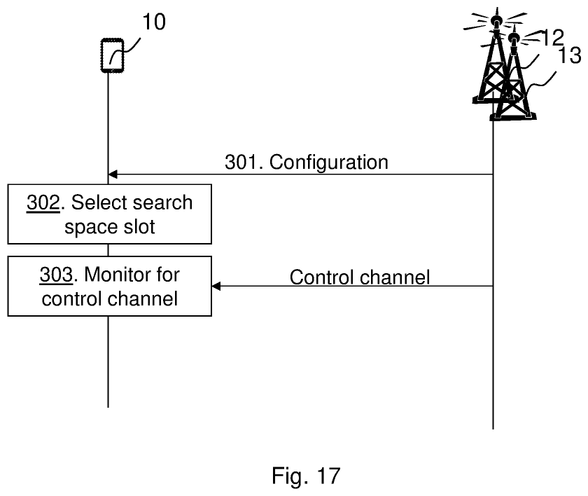

FIG. 17 is a combined flowchart and signalling scheme according to embodiments herein. The actions may be performed in any suitable order.

Action 301. The radio network node such as the first radio network node 12 or the second radio network node 13 may transmit configuration to the UE for monitoring a PCell and/or Scell. The configuration is for search space comprising a period in terms of number of slot groups; an offset in terms of number of slot groups within the period; a duration in terms of number of slot groups within the period, and an indication of symbol with a slot. Furthermore, the configuration may comprise the deciding indication for the UE 10 to select a search space slot according to any of the methods mentioned herein.

Action 302. The UE 10 selects, for a Pcell and/or an Scell, a search space slot within a slot group according to any of the embodiments herein.

Action 303. The UE 10 monitors the selected search space for the control channel as configured according to any of the embodiments mentioned herein.

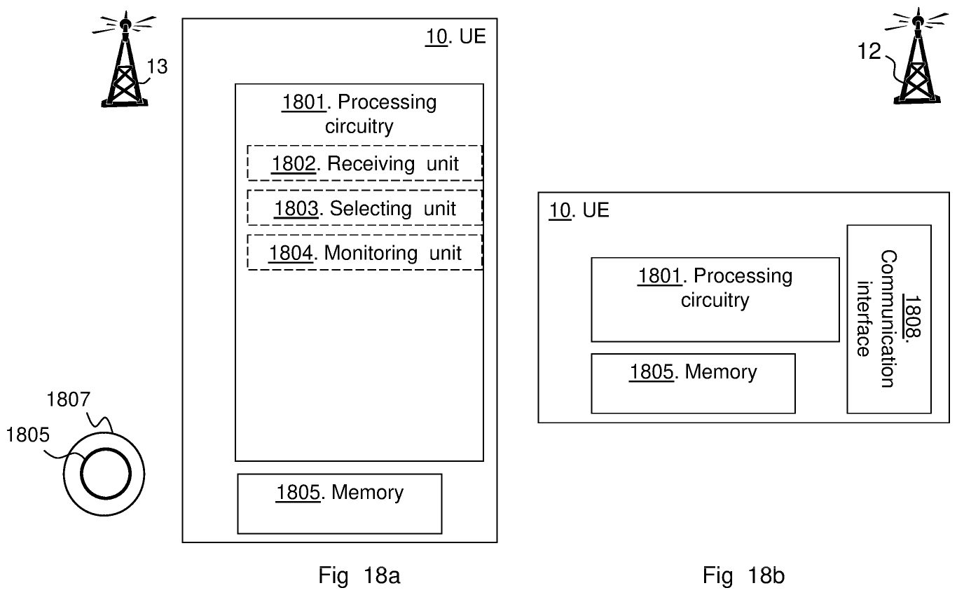

FIGS. 18a-18b are block diagrams depicting the UE for monitoring a control channel in the wireless communication network, such as selecting search space, in the wireless communication network 1 according to embodiments herein.

The UE 10 may comprise processing circuitry 1801, e.g. one or more processors, configured to perform the methods herein.

The UE 10 may comprise a receiving unit 1802, e.g. a receiver or a transceiver. The UE 10, the processing circuitry 1801, and/or the receiving unit 1802 may be configured to receive the configuration from the radio network node. The configuration may comprise a period in terms of number of slot groups; an offset in terms of number of slot groups within the period; a duration in terms of number of slot groups within the period, and an indication of symbol within a slot. The configuration may further comprise the deciding indication indicating a method to use to select search space slot.

The UE 10 may comprise a selecting unit 1803. The UE 10, the processing circuitry 1801, and/or the selecting unit 1803 is configured to select for a Pcell and/or an Scell, the search space slot within the slot group according to any of the embodiments herein. The UE 10, the processing circuitry 1801, and/or the selecting unit 1803 is configured to select for a Pcell, and/or a Scell, a search space slot within a slot group wherein the slot group is arranged in an X-slot group pattern, wherein the slot group is of a size of X-slots, and the X-slot group pattern is fixed relative to a reference time location and common for UEs operating PDCCH monitoring X slots. The UE 10, the processing circuitry 1801, and/or the selecting unit 1803 may be configured to select the search space slot by determining a search space monitoring slot within an X-slot group based on a location of a first slot of a type0 CSS monitoring occasion for the PCell, a PSCell, and/or the SCell within a slot group.

The UE 10 may comprise a monitoring unit 1804. The UE 10, the processing circuitry 1801, and/or the monitoring unit 1804 is configured to monitor the selected search space, e.g., as configured according to any of the embodiments mentioned herein. The UE 10, the processing circuitry 1801, and/or the monitoring unit 1804 is configured to monitor the selected search space slot or slots for a control channel of the Pcell, and/or the Scell. The UE 10, the processing circuitry 1801, and/or the selecting unit 1803 may be configured to select the search space slot by determining a slot group grid offset for a SCell based on at least a slot index of a first slot of a type0 CSS monitoring occasion on the PCell or a PSCell. The UE 10, the processing circuitry 1801, and/or the selecting unit 1803 may be configured to change search space in response to receiving an instruction from a radio network node to change search space, or by autonomously determining a new type0 PDCCH monitoring location during a random access procedure.

The UE 10 further comprises a memory 1805. The memory comprises one or more units to be used to store data on, such as configuration, slot number, search space, indications, thresholds, indications, RSs, strengths or qualities, UL grants, indications, requests, commands, timers, applications to perform the methods disclosed herein when being executed, and similar. Thus, embodiments herein may disclose a UE for monitoring a control channel in a wireless communication network, wherein the UE comprises processing circuitry and a memory, said memory comprising instructions executable by said processing circuitry whereby said UE is operative to perform any of the methods herein. The UE comprises a communication interface 1808 comprising a transmitter, a receiver and/or one or more antennas.

The methods according to the embodiments described herein for the UE 10 are respectively implemented by means of e.g. a computer program product 1806 or a computer program, comprising instructions, i.e., software code portions, which, when executed on at least one processor, cause the at least one processor to carry out the actions described herein, as performed by the UE 10. The computer program product 1806 may be stored on a computer-readable storage medium 1807, e.g. a universal serial bus (USB) stick, a disc or similar. The computer-readable storage medium 1807, having stored thereon the computer program product, may comprise the instructions which, when executed on at least one processor, cause the at least one processor to carry out the actions described herein, as performed by the UE 10. In some embodiments the computer-readable storage medium may be a non-transitory or a transitory computer-readable storage medium.

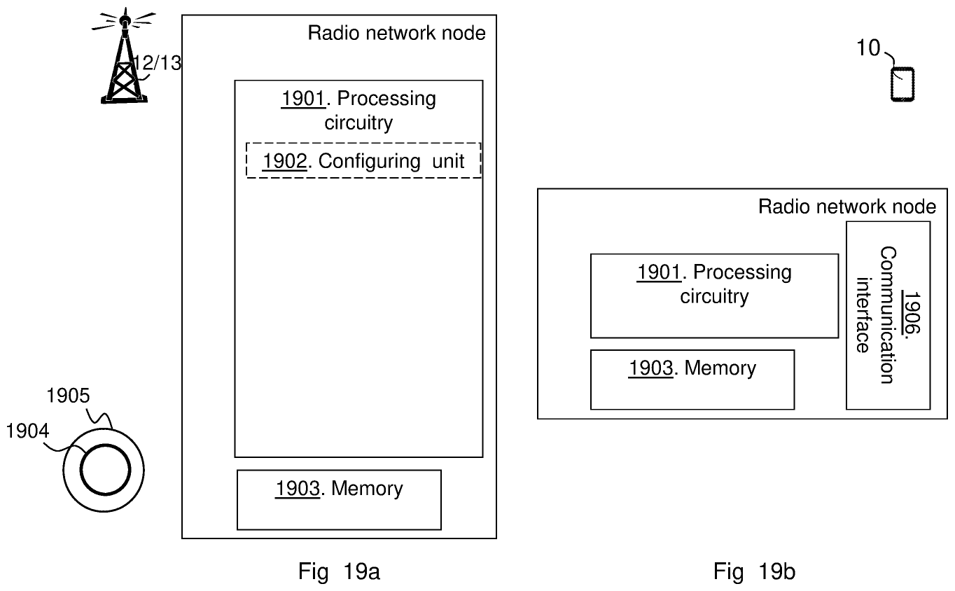

FIG. 19a-19b are block diagrams depicting the radio network node for handling communication such as monitoring of a control channel in the wireless communication network 1, according to embodiments herein.

The radio network node may comprise processing circuitry 1901, e.g. one or more processors, configured to perform the methods herein.

The radio network node may comprise a configuring unit 1902, e.g. a transmitter or a transceiver. The radio network node, the processing circuitry 1901, and/or the configuring unit 1902 is configured to transmit configuration to the UE for monitoring, for a PCell and/or Scell, the search space slot within the slot group wherein the slot group is arranged in an X-slot group pattern, wherein the slot group is of a size of X-slots, and the X-slot group pattern is fixed relative to the reference time location and common for UEs operating PDCCH monitoring X slots. The configuration may comprise the period in terms of number of slot groups; the offset in terms of number of slot groups within the period; the duration in terms of number of slot groups within the period, and the indication of symbol within a slot. The configuration may further comprise the deciding indication indicating a method to use to select search space slot. The configuration is for search space comprising a period in terms of number of slot groups; an offset in terms of number of slot groups within the period; a duration in terms of number of slot groups within the period, and an indication of symbol with a slot. Furthermore, the configuration comprises the deciding indication for the UE to select a search space slot according to any of the methods mentioned herein. The radio network node, the processing circuitry 1901, and/or the configuring unit 1902 is configured to transmit the instruction to the UE 10 to change search space.

The radio network node further comprises a memory 1903. The memory comprises one or more units to be used to store data on, such as configurations, thresholds, measurements, aggregation information, indications, strengths or qualities, grants, scheduling information, timers, applications to perform the methods disclosed herein when being executed, and similar. Thus, embodiments herein may disclose a radio network node for handling communication such as monitoring a control channel in a wireless communication network, wherein the radio network node comprises processing circuitry and a memory, said memory comprising instructions executable by said processing circuitry whereby said radio network node is operative to perform any of the methods herein. The radio network node comprises a communication interface 1906 comprising transmitter, receiver, transceiver and/or one or more antennas.

The methods according to the embodiments described herein for the radio network node are respectively implemented by means of e.g. a computer program product 1904 or a computer program product, comprising instructions, i.e., software code portions, which, when executed on at least one processor, cause the at least one processor to carry out the actions described herein, as performed by the radio network node. The computer program product 1904 may be stored on a computer-readable storage medium 1905, e.g., a USB stick, a disc or similar. The computer-readable storage medium 1905, having stored thereon the computer program product, may comprise the instructions which, when executed on at least one processor, cause the at least one processor to carry out the actions described herein, as performed by the radio network node. In some embodiments, the computer-readable storage medium may be a non-transitory or transitory computer-readable storage medium.

In some embodiments a more general term “radio network node” is used and it can correspond to any type of radio network node or any network node, which communicates with a wireless device and/or with another network node. Examples of network nodes are NodeB, Master eNB, Secondary eNB, a network node belonging to Master cell group (MCG) or Secondary Cell Group (SCG), base station (BS), multi-standard radio (MSR) radio node such as MSR BS, eNodeB, network controller, radio network controller (RNC), base station controller (BSC), relay, donor node controlling relay, base transceiver station (BTS), access point (AP), transmission points, transmission nodes, Remote Radio Unit (RRU), Remote Radio Head (RRH), nodes in distributed antenna system (DAS), core network node e.g. Mobility Switching Centre (MSC), Mobile Management Entity (MME) etc., Operation and Maintenance (O&M), Operation Support System (OSS), Self-Organizing Network (SON), positioning node e.g. Evolved Serving Mobile Location Centre (E-SMLC), Minimizing Drive Test (MDT) etc.

In some embodiments the non-limiting term wireless device or user equipment (UE) is used and it refers to any type of wireless device communicating with a network node and/or with another UE in a cellular or mobile communication system. Examples of UE are target device, device-to-device (D2D) UE, proximity capable UE (aka ProSe UE), machine type UE or UE capable of machine to machine (M2M) communication, PDA, PAD, Tablet, mobile terminals, smart phone, laptop embedded equipped (LEE), laptop mounted equipment (LME), USB dongles etc.

The embodiments are described for 5G. However the embodiments are applicable to any RAT or multi-RAT systems, where the UE receives and/or transmit signals (e.g. data) e.g. LTE, LTE FDD/TDD, WCDMA/HSPA, GSM/GERAN, Wi Fi, WLAN, CDMA2000 etc.

As will be readily understood by those familiar with communications design, that functions means or modules may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of communications devices will appreciate the cost, performance, and maintenance trade-offs inherent in these design choices.

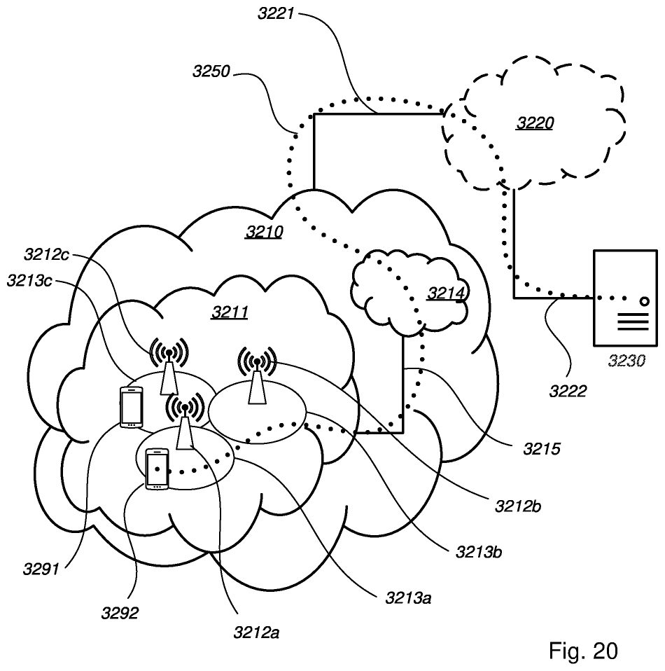

With reference to FIG. 20, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points being examples of the radio network node 12 herein, each defining a corresponding coverage area 3213a, 3213b, 3213c. Each base station 3212a, 3212b, 3212c is connectable to the core network 3214 over a wired or wireless connection 3215. A first user equipment (UE) 3291, being an example of the UE 10, located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 20 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

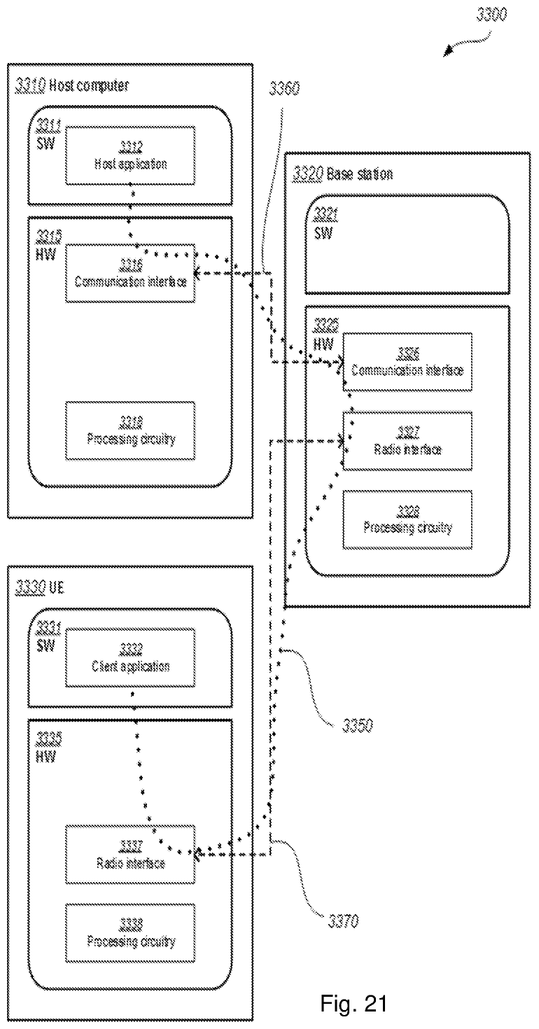

Example implementations, in accordance with an embodiment, of the UE, base station and host computer discussed in the preceding paragraphs will now be described with reference to FIG. 21. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 21) served by the base station 3320. The communication interface 3326 may be configured to facilitate a connection 3360 to the host computer 3310. The connection 3360 may be direct or it may pass through a core network (not shown in FIG. 21) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 21 may be identical to the host computer 3230, one of the base stations 3212a, 3212b, 3212c and one of the UEs 3291, 3292 of FIG. 20, respectively. This is to say, the inner workings of these entities may be as shown in FIG. 21 and independently, the surrounding network topology may be that of FIG. 20.

In FIG. 21, the OTT connection 3350 has been drawn abstractly to illustrate the communication between the host computer 3310 and the user equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the performance since signalling of the control channel in CA or DC is handled more efficiently and thereby provide benefits such as better battery consumption, reduced user waiting time, and better responsiveness.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

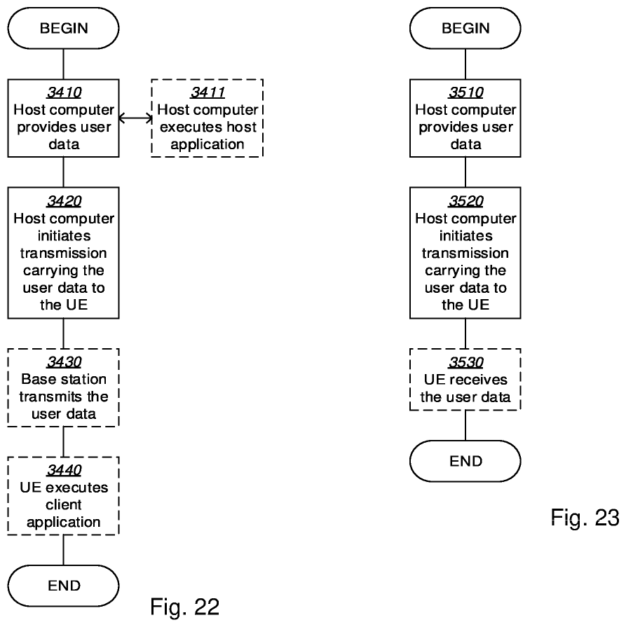

FIG. 22 is a flowchart illustrating a method implemented in a communication system, in accordance with one embodiment. The communication system includes a host computer, a base station and a UE which may be those described with reference to FIGS. 20 and 21. For simplicity of the present disclosure, only drawing references to FIG. 22 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 23 is a flowchart illustrating a method implemented in a communication system, in accordance with one embodiment. The communication system includes a host computer, a base station and a UE which may be those described with reference to FIGS. 20 and 21. For simplicity of the present disclosure, only drawing references to FIG. 23 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

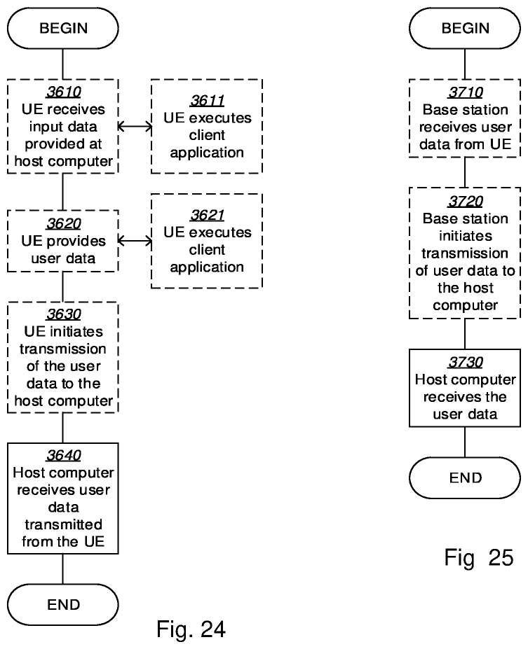

FIG. 24 is a flowchart illustrating a method implemented in a communication system, in accordance with one embodiment. The communication system includes a host computer, a base station and a UE which may be those described with reference to FIGS. 20 and 21. For simplicity of the present disclosure, only drawing references to FIG. 24 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 25 is a flowchart illustrating a method implemented in a communication system, in accordance with one embodiment. The communication system includes a host computer, a base station and a UE which may be those described with reference to FIGS. 20 and 21. For simplicity of the present disclosure, only drawing references to FIG. 25 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

### Abbreviations

BWP Bandwidth part
CCE Control channel element
CORESET Control resource set
CRB Common resource block
CSI Channel-state information
CSI-RS CSI reference signal
DCI Downlink Control Information
DM-RS Demodulation reference signal
FR1 Frequency range 1 as defined in [8, TS 38.104]
FR2 Frequency range 2 as defined in [8, TS 38.104]
IE Information element
PBCH Physical broadcast channel
PDCCH Physical downlink control channel
PDSCH Physical downlink shared channel
PRACH Physical random-access channel
PRB Physical resource block
PSD Power spectral density
PSS Primary synchronization signal
PT-RS Phase-tracking reference signal
PUCCH Physical uplink control channel
PUSCH Physical uplink shared channel
REG Resource-element group
SIB System information block
SRS Sounding reference signal
SSS Secondary synchronization signal
VRB Virtual resource block

1. A method performed by a user equipment, UE, for handling communication in a wireless communication network, the method comprising:
receiving a configuration from a radio network node, the configuration comprising:
a period in terms of number of slot groups;
an offset in terms of number of slot groups within the period;
a duration in terms of number of slot groups within the period; and
an indication of symbol within a slot;
selecting for one or both of a primary cell, Pcell, and a secondary cell, Scell, a search space slot within a slot group, the slot group being arranged in an X-slot group pattern, the slot group being of a size of X-slots, and the X-slot group pattern is fixed relative to a reference time location and common for UEs operating physical downlink control channel, PDCCH, monitoring X slots taking the information in the received configuration into account; and
monitoring the selected search space slot or slots for a control channel of the one or both of the Pcell and the Scell.

2. (canceled)

3. (canceled)

4. The method according to claim 1, wherein the configuration further comprises a deciding indication indicating a method to use to select search space slot.

5. The method according to claim 1, wherein selecting the search space slot comprises determining a search space monitoring slot within an X-slot group based on a location of a first slot of a type0 Common search space, CSS, monitoring occasion for one or more of the PCell, a primary secondary cell, PSCell, and the SCell within a slot group.

6. The method according to claim 1, wherein selecting the search space slot comprises determining a slot group grid offset for a SCell based on at least a slot index of a first slot of a type0 Common search space, CSS, monitoring occasion on the PCell or primary secondary cell, PSCell.

7. The method according to claim 1, further comprising:
changing search space in response to receiving an instruction from a radio network node to change search space, or by autonomously determining a new type0 PDCCH monitoring location during a random access procedure.

8. A method performed by a radio network node for handling communication in a wireless communication network, the method comprising:
transmitting configuration to a user equipment, UE, for monitoring, for one or both of a primary cell, Pcell, and a secondary cell, Scell, a search space slot within a slot group, the slot group being arranged in an X-slot group pattern, the slot group being of a size of X-slots, and the X-slot group pattern is fixed relative to a reference time location and common for UEs operating physical downlink control channel, PDCCH, monitoring X slots, the configuration comprising:
a period in terms of number of slot groups;
an offset in terms of number of slot groups within the period;
a duration in terms of number of slot groups within the period; and
an indication of symbol within a slot.

9. (canceled)

10. The method according to claim 8, wherein the configuration further comprises a deciding indication indicating a method to use to select search space.

11. The method according to claim 8, further comprising:
transmitting an instruction to the UE to change search space slot.

12. A user equipment, UE, for handling communication in a wireless communication network, the UE being configured to:
receive a configuration from a radio network node, the configuration comprising:
a period in terms of number of slot groups;
an offset in terms of number of slot groups within the period;
a duration in terms of number of slot groups within the period; and
an indication of symbol within a slot;
select for one or both of a primary cell, Pcell, and a secondary cell, Scell, a search space slot within a slot group, the slot group being arranged in an X-slot group pattern, the slot group being of a size of X-slots, and the X-slot group pattern is fixed relative to a reference time location and common for UEs operating physical downlink control channel, PDCCH, monitoring X slots taking the information in the received configuration into account; and
monitor the selected search space slot or slots for a control channel of the one or both of the Pcell, and the Scell.

13. (canceled)

14. (canceled)

15. The UE according to claim 12, wherein the configuration further comprises a deciding indication indicating a method to use to select search space slot.

16. The UE according to claim 12, wherein the UE is configured to select the search space slot by determining a search space monitoring slot within an X-slot group based on a location of a first slot of a type0 Common search space, CSS, monitoring occasion for one or more of the PCell, a primary secondary cell, PSCell, and the SCell within a slot group.

17. The UE according to claim 12, wherein the UE is configured to select the search space slot by determining a slot group grid offset for a SCell based on at least a slot index of a first slot of a type0 Common search space, CSS, monitoring occasion on the PCell or a primary secondary cell, PSCell.

18. The UE according to claim 12, wherein the UE is configured to:
change search space in response to receiving an instruction from a radio network node to change search space, or by autonomously determining a new type0 PDCCH monitoring location during a random access procedure.

19. A radio network node for handling communication in a wireless communication network, the radio network node being configured to:
transmit configuration to a user equipment, UE, for monitoring, for one or both of a primary cell, Pcell, and a secondary cell, Scell, a search space slot within a slot group, the slot group is arranged in an X-slot group pattern, the slot group being of a size of X-slots, and the X-slot group pattern is fixed relative to a reference time location and common for UEs operating physical downlink control channel, PDCCH, monitoring X slots the configuration comprising:
a period in terms of number of slot groups;
an offset in terms of number of slot groups within the period;
a duration in terms of number of slot groups within the period; and
an indication of symbol within a slot.

20. (canceled)

21. The radio network node according to claim 19, wherein the configuration further comprises a deciding indication indicating a method to use to select search space slot.

22.-24. (canceled)
